(19) United States
(12) Patent Application Publication
(10) Pub. No.: US 2025/0332058 A1
(43) Pub. Date: Oct. 30, 2025

(54) Systems and Methods for Wireless Magnetic Mechanotherapy

(71) Applicant: The Board of Trustees of the University of Illinois, Urbana, IL (US)

(72) Inventors: Xiaojia Shelly Zhang, Urbana, IL (US); Hua Wang, Urbana, IL (US); Chao Wang, Urbana, IL (US); Zhi Zhao, Urbana, IL (US); Joonsu Han, Urbana, IL (US); Arvin Ardebili Sharma, Urbana, IL (US)

(21) Appl. No.: 19/187,538

(22) Filed: Apr. 23, 2025

Related U.S. Application Data
(60) Provisional application No. 63/638,410, filed on Apr. 24, 2024.

(51) Int. Cl. A61H 7/00

(52) U.S. Cl. CPC A61H 7/007; A61H 2201/1207

(57) ABSTRACT

Example devices, systems, and methods are described for mechanotherapy applications. The disclosed device is made of a plurality of composite elements. Each composite element includes a soft matrix material and magnetic particles embedded in the soft matrix material. The magnetic particles provide magnetic domains having a given orientation. The plurality of composite elements is provided in an initial state. In the presence of an applied magnetic field, the plurality of composite elements are displaced from the initial state into an actuated state. Methods for fabricating such a device are provided. This method includes determining an initial state geometry and respective magnetic domain orientations, forming a mold; casting the plurality of composite elements; and adjusting, with an external magnetic saturation field, an orientation of at least one magnetic domain of at least one composite element. The system includes the device, and a controllable magnet to generate the applied magnetic field.

### CROSS-REFERENCE TO RELATED APPLICATIONS

The present application is a non-provisional patent application claiming priority to U.S. Provisional Patent Application No. 63/638,410, filed on Apr. 24, 2024, the contents of which are hereby incorporated by reference.

### STATEMENT REGARDING FEDERALLY SPONSORED RESEARCH OR DEVELOPMENT

This invention was made with government support under contract number N66001-23-1-4013 awarded by the Department of Defense. The government has certain rights in the invention.

### BACKGROUND

Mechanotherapy, which functions by applying mechanical forces to injured or diseased tissues, is a promising non-invasive treatment option for tissue repair and rehabilitation. Recent advances have uncovered the ability of mechanical stimuli to regulate cell proliferation, cell differentiation, and inflammatory responses, thereby facilitating the restoration of injured tissues. One main challenge, though, is the development of advanced actuation systems capable of generating controllable forces or strains toward the target tissues. Bulky robotic devices equipped with real-time force control were able to apply cyclic compressive loading to tissues and improve the recovery of injured leg muscles in a mouse model. However, the bulkiness and complexity of these robots limit their widespread use, and pose a concern on the controllability of forces that can be applied to a certain small region of tissues and tissue microenvironment. Moreover, these robots could only be used to stimulate surface tissues. More recently, a mechanically active gel-elastomer-nitinol tissue adhesive (MAGENTA) that can be implanted over tissues was developed to generate forces towards the underlying tissues. While this device was able to stimulate muscles with a desired strength and attenuate muscle atrophy, the necessity of embedding an electrical wire and utilizing electricity to generate heat to contract the thermoresponsive nitinol and generate forces poses a concern for practical use.

Moving forward, the development of advanced actuation systems that are (1) biocompatible and easily scalable; (2) capable of achieving precise programmable, controllable, and various modes of loading to deep tissues; and (3) feasible for remote and wireless control will facilitate systematic and controlled preclinical and clinical studies. While significant progress has been made in the field of soft robotics in generating mechanical actuation, many mechanisms lack wireless or remote control and are not suitable for biomedical applications.

### SUMMARY

Mechanotherapy has emerged as a promising treatment for tissue injury. However, existing robots for mechanotherapy are often designed on intuition, lack remote and wireless control, and have limited motion modes. Herein, through topology optimization and hybrid fabrication, wireless magnetoactive soft robots are created that can achieve various modes of programmatic deformations under remote magnetic actuation and apply mechanical forces to tissues in a precise and predictable manner. These soft robots can quickly and wirelessly deform under magnetic actuation and are able to deliver compressing, stretching, and shearing forces to the surrounding tissues. This design framework considers the hierarchical tissue robot interaction and, therefore, can custom-design the soft robots for different types of tissues with varied mechanical properties. It is shown that these custom-designed robots with different motion modes can induce precise deformations of porcine muscle, liver, and heart tissues with excellent durability. These soft robots, the underlying design principles, and the fabrication approach provide a new avenue for developing next-generation mechanotherapy.

In an aspect, a device is provided. This device includes a plurality of composite elements. Each composite element includes a soft matrix material and magnetic particles embedded in the soft matrix material. The magnetic particles provide one or more magnetic domains having a given orientation. The plurality of composite elements is provided in an initial state, and the plurality of composite elements is configured to be displaced into an actuated state in the presence of an applied magnetic field.

In another aspect, a method is provided. This method includes determining an initial state geometry and respective magnetic domain orientation for the plurality of composite elements. The plurality of composite elements is configured to be displaced into an actuated state geometry in the presence of an applied magnetic field. The method also includes forming at least one mold based on the determined initial state geometry and respective magnetic domain orientation. Additionally, the method includes casting, by way of the at least one mold, the plurality of composite elements. Furthermore, the method includes adjusting, with an external magnetic saturation field, an orientation of at least one magnetic domain of at least one composite element.

In another aspect, a system is provided. The system includes a device and a controllable magnet, where the device includes a plurality of composite elements. Each composite element includes a soft matrix material and magnetic particles embedded in the soft matrix material. The magnetic particles provide one or more magnetic domains having a given orientation. The plurality of composite elements is provided in an initial state, and the plurality of composite elements is configured to be displaced into an actuated state in the presence of an applied magnetic field.

Without wishing to be bound by any particular theory, there can be discussion herein of beliefs or understandings of underlying principles or mechanisms relating to embodiments of the disclosure. It is recognized that regardless of the ultimate correctness of any explanation or hypothesis, an embodiment of the disclosure can nonetheless be operative and useful.

The foregoing and other objects and features of the disclosure will become more apparent from the following detailed description, which proceeds with reference to the accompanying figures.

Further embodiments, forms, features, aspects, benefits, objects, and advantages of the present application shall become apparent from the detailed description and figures provided herewith.

### BRIEF DESCRIPTION OF THE FIGURES

The above, as well as additional, features will be better understood through the following illustrative and non-limiting detailed description of example embodiments, with reference to the appended drawings.

FIG. 1A illustrates a potential application of a wireless implantable magneto-active soft robot and its actuation mechanism to generate mechanical stimulation to tissues, according to an example embodiment.

FIG. 1B illustrates a design setup and target tissue deformation, according to an example embodiment.

FIG. 1C illustrates topology optimization of a robot's geometry and magnetization distribution, according to an example embodiment.

FIG. 1D illustrates cyclic magnetic actuation of an optimized magneto-active robot and a fabricated robot under cyclic magnetic actuation, according to an example embodiment.

FIG. 1E illustrates ex vivo experiments of a fabricated robot programmed with multi-modal deformation and applications on different types of tissues, according to an example embodiment.

FIG. 2A illustrates a fabrication process of optimized designs, according to an example embodiment.

FIG. 2B illustrates a stress-strain relationship of materials, according to an example embodiment.

FIG. 2C illustrates an initial Young's modulus for PDMS (20:1 base-to-agent ratio) with 0 vol %, 15 vol %, and 25 vol % NdFeB magnetic particles, according to an example embodiment.

FIG. 2D illustrates measured residual magnetic flux density for material with different volume fractions of magnetic particles and a magnetization hysteresis loop, according to an example embodiment.

FIG. 3A illustrates cell viability after being cultured on the biomaterials for 72 hours, according to an example embodiment.

FIG. 3B illustrates a timeline of in vivo biocompatibility, according to an example embodiment.

FIG. 3C illustrates an implantation process, according to an example embodiment.

FIG. 3D illustrates body weight of mice over time, according to an example embodiment.

FIG. 3E illustrates a mouse at 8 days post implantation of PDMS containing 25 vol % NdFeB magnetic particles, according to an example embodiment.

FIG. 3F illustrates percentages of CD45⁺ immune cells in the implant area, according to an example embodiment.

FIG. 3G illustrates percentages of CD45⁺CD11b⁺CD11c⁺ dendritic cells in the implant area, according to an example embodiment.

FIG. 3H illustrates percentages of CD45⁺CD11b⁺F4/80⁺ macrophages in the implant area, according to an example embodiment.

FIG. 31 illustrates percentages of CD45⁺CD11b⁺Gr1⁺ neutrophils in the implant area, according to an example embodiment.

FIG. 4A illustrates target biaxial motions, optimized design, intuitive design, and negative control, with arrows indicating the embedded magnetization directions, according to an example embodiment.

FIG. 4B illustrates biaxial stretching actuation (FEA and experiment) of optimized and intuitive designs under a positive y-direction magnetic field

$$\vert {B}_{a}^{( 1 )} \vert = 50 mT ,$$

according to an example embodiment.

FIG. 4C illustrates cyclic performance test of biaxial stretching under actuation rate of 0.1 Hz and deformation process transitioning from magnetic OFF to magnetic ON, according to an example embodiment.

FIG. 4D illustrates biaxial compressing actuation (FEA and experiment) of optimized and intuitive designs under a negative y-direction magnetic field

$$\vert {B}_{a}^{( 2 )} \vert = 50 mT ,$$

according to an example embodiment.

FIG. 4E illustrates cyclic performance test of biaxial compressing under actuation rate of 0.1 Hz and deformation process transitioning from magnetic OFF to magnetic ON, according to an example embodiment.

FIG. 5A illustrates target uniaxial motion, according to an example embodiment.

FIG. 5B illustrates target shearing motion, according to an example embodiment.

FIG. 5C illustrates target dual-mode motion, according to an example embodiment.

FIG. 5D illustrates actuation (FEA and experiment) of optimized and intuitive designs under a positive y-direction magnetic field

$$\vert {B}_{a}^{( 1 )} \vert = 50 mT$$

for uniaxial motion, according to an example embodiment.

FIG. 5E illustrates actuation (FEA and experiment) of optimized and intuitive designs under a positive y-direction magnetic field

$$\vert {B}_{a}^{( 1 )} \vert = 50 mT$$

for shearing motion, according to an example embodiment

FIG. 5F illustrates actuation (FEA and experiment) of dual-mode optimized design under positive y-direction and x-direction magnetic fields with

$$\vert {B}_{a}^{( 1 )} \vert = \vert {B}_{a}^{( 2 )} \vert = 50 mT ,$$

respectively, according to an example embodiment.

FIG. 5G illustrates actuated displacements (FEA and experiment) of optimized and intuitive designs programmed with uniaxial motion under different magnitude of

$${B}_{a}^{( 1 )} ,$$

according to an example embodiment.

FIG. 5H illustrates rotational angles (FEA and experiment) of optimized and intuitive designs programmed with shearing motion under

$$\vert {B}_{a}^{( 1 )} \vert = 50 mT ,$$

according to an example embodiment.

FIG. 5I illustrates actuated displacements and rotational angles (FEA and experiment) for optimized design programmed with the dual-mode motion, according to an example embodiment.

FIG. 6A illustrates an FEA result of correlation between actuated tissue displacement and tissue depth for the robot with biaxial stretching motion and the simulation setup, according to an example embodiment.

FIG. 6B illustrates experimental measurements of average displacements at control points within myocardial tissue over 2 cycles of magnetic ON and OFF, according to an example embodiment.

FIG. 6C illustrates experimental measurements of average displacements at control points within myocardial tissue over 50 cycles of magnetic ON and OFF, according to an example embodiment.

FIG. 6D illustrates experimental measurements of average displacements at control points within liver tissue over 2 cycles of magnetic ON and OFF, according to an example embodiment.

FIG. 6E illustrates experimental measurements of average displacements at control points within liver tissue over 50 cycles of magnetic ON and OFF, according to an example embodiment.

FIG. 6F illustrates experimental measurements of average displacements at control points within skeletal muscle tissue over 2 cycles of magnetic ON and OFF, according to an example embodiment.

FIG. 6G illustrates experimental measurements of average displacements at control points within skeletal muscle tissue over 50 cycles of magnetic ON and OFF, according to an example embodiment.

FIG. 6H illustrates displacement fields acquired by a digital image correlation analysis of the skeletal muscle tissue deformation actuated by biaxial stretching and compressing motions of an optimized robot, according to an example embodiment.

FIG. 6I illustrates a stress-strain relationship of skeletal muscle, liver, and myocardium tissues, according to an example embodiment.

FIG. 6J illustrates a comparison of experimentally measured and numerically predicted average stretching and compressing displacements at control points in skeletal muscle tissue, according to an example embodiment.

FIG. 6K illustrates a comparison of experimentally measured and numerically predicted average stretching and compressing displacements at control points in liver tissue, according to an example embodiment.

FIG. 6L illustrates a comparison of experimentally measured and numerically predicted average stretching and compressing displacements at control points in myocardium tissue, according to an example embodiment.

FIG. 7A illustrates average and normalized tissue displacements under uniaxial motion at control points evaluated under different magnitudes of the applied magnetic field and photos of tissue during actuation, according to an example embodiment.

FIG. 7B illustrates a comparison of experimentally measured and numerically predicted average uniaxial motion at control points under B⁽¹⁾=50 mT during one-time actuation, according to an example embodiment.

FIG. 7C illustrates strain (top) and stress (bottom) fields of skeletal muscle tissue actuated by uniaxial motion of an optimized robot, according to an example embodiment.

FIG. 7D illustrates displacement fields (left: uₓ; right: u_{y}) acquired by DIC analysis (top) and FEA (bottom) of skeletal muscle tissue actuated by a shearing motion of an optimized robot, according to an example embodiment.

FIG. 7E illustrates a comparison of experimentally measured and numerically predicted average shearing motion at control points during one-time actuation, according to an example embodiment.

FIG. 7F illustrates experimentally measured average and normalized shearing motion for 50 times of actuation, according to an example embodiment.

FIG. 7G illustrates displacement fields acquired by DIC analysis of skeletal muscle tissue actuated by a dual-mode motion of an optimized robot: uₓ of the stretching mode (top); u_{y} of the shearing mode (bottom), according to an example embodiment.

FIG. 7H illustrates a comparison of experimentally measured and numerically predicted average dual-mode motion at control points during one-time actuation in mode-1 stretching, according to an example embodiment.

FIG. 7I illustrates a comparison of experimentally measured and numerically predicted average dual-mode motion at control points during one-time actuation in mode-2 shearing, according to an example embodiment.

FIG. 8A illustrates uniaxial tensile and compressive testing tissue samples, according to an example embodiment.

FIG. 8B illustrates a testing setup for uniaxial tensile loading, according to an example embodiment.

FIG. 8C illustrates a testing setup for compressive loading, according to an example embodiment.

FIG. 8D illustrates measured and fitted stress-strain curves for the skeletal muscle tissues, according to an example embodiment.

FIG. 8E illustrates measured and fitted stress-strain curves for liver tissues, according to an example embodiment.

FIG. 8F illustrates measured and fitted stress-strain curves for myocardium tissues, according to an example embodiment.

FIG. 9A illustrates selective compression and tension samples for pure PDMS (20:1 base-to-agent ratio), according to an example embodiment.

FIG. 9B illustrates selective compression and tension samples for hard magnetic soft materials, according to an example embodiment.

FIG. 9C illustrates characterized stress-strain curves for Eco-flex 00-30, according to an example embodiment.

FIG. 9D illustrates characterized stress-strain curves for PDMS (20:1 base-to-agent ratio), according to an example embodiment.

FIG. 9E illustrates characterized stress-strain curves for HMSM with 15% vol NdFeB magnetic particles, according to an example embodiment.

FIG. 9F illustrates characterized stress-strain curves for HMSM with 25% vol NdFeB magnetic particles, according to an example embodiment.

FIG. 10A illustrates an experimental setup with magnetic actuation, according to an example embodiment.

FIG. 10B illustrates a setup for robot performance tests, according to an example embodiment.

FIG. 10C illustrates the setup for an ex vivo experiment, according to an example embodiment.

FIG. 11 illustrates a measurement of the magnetic field generated by a Helmholtz coil within a workspace (30 mm×30 mm), according to an example embodiment.

FIG. 12A illustrates a device including a plurality of composite elements, according to an example embodiment.

FIG. 12B illustrates a device with an initial state and an actuated state, according to an example embodiment.

FIG. 13 illustrates a method for fabricating a device, according to an example embodiment.

FIG. 14 illustrates a system including a device and a controllable magnet, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

### Overview

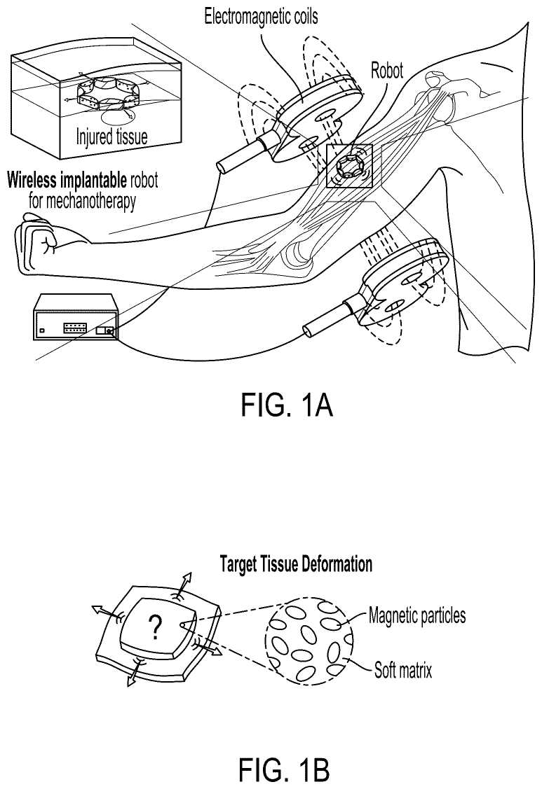

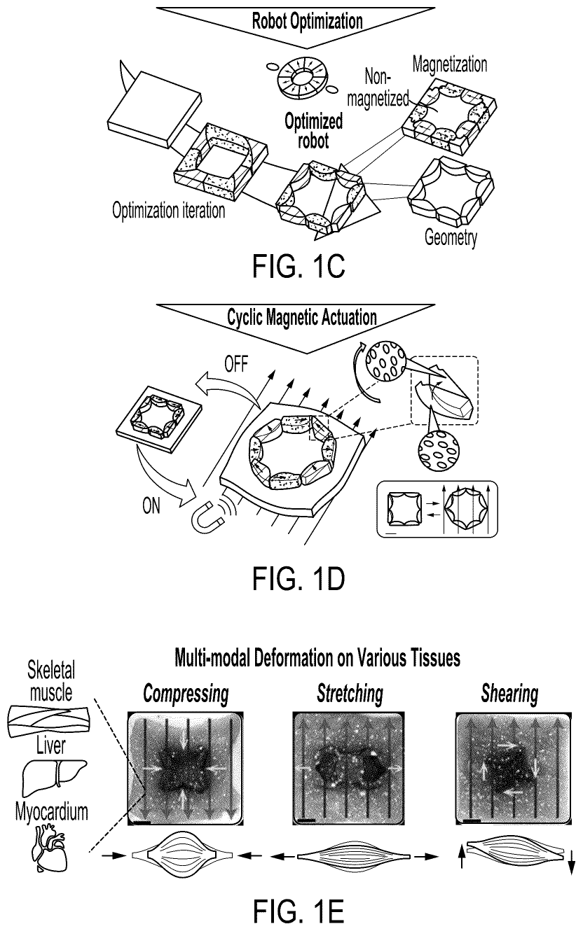

Leveraging the hard-magnetic soft material and the multiphysics topology optimization approach, here the development of wireless magneto-active soft robots that can mechanically stimulate and deform various tissues (skeletal muscle, liver, and myocardium) in a wireless, programmable, and precise manner (FIG. 1A-1E) is reported. The robots, which can easily adhere to tissues, can also induce different motion modes (compressing, stretching, and shearing) of the underlying tissues, all in a predictable and precise manner. This topology optimization approach takes into account the complex mechanical properties of both tissues and robotic materials, as well as their hierarchical interactions, and thus allows for custom-design of robots for different types of tissues. Robots are fabricated via a facile and biocompatible mold-casting approach. It is shown that the fabricated robots display as-designed motion modes and speeds, with or without attachment to tissues, in the presence of magnetic actuation. By switching on and off the magnetic field, cyclic mechanical loading with robust durability can also be achieved.

### Biomaterial Robot Design, Fabrication, Characterization, and Biocompatibility Evaluation

The inverse design paradigm and validation process of the biomaterial robot are depicted in FIG. 1A-1E. The design setup is illustrated in FIG. 1A-1B. First, the design domain in space for the robot is defined, which will be positioned on the injured tissue surface. Under magnetic actuation, the movement of the magnetic-responsive robots triggers the movement of the underlying tissue (robots tightly adhere to the tissue). Then, the target tissue deformations are specified (FIG. 1B) serving as the objective of the topology optimization framework. FIG. 1C illustrates the optimization process. In this study, two sets of design variables are incorporated within the topology optimization framework: the biomaterial robot geometry represented by the density variable distribution and the magnetization distribution. Given the target tissue deformation and considering the mechanical properties of both the tissue and the biomaterial, the topology optimization framework optimizes the robot's geometry and magnetization. This process results in the generation of the final optimized robotic design, as illustrated in FIG. 1C. When applying the magnetic field (FIG. 1D), the magnetic-responsive robot aligns with the applied magnetic field direction through magnetic torque under wireless and remote control, generating robot motion and inducing tissue deformation. Once the optimized designs are obtained, ex vivo tests are conducted on various porcine tissues (FIG. 1E), including skeletal muscle, liver, and myocardium, to verify the actuation performance and durability of the robots.

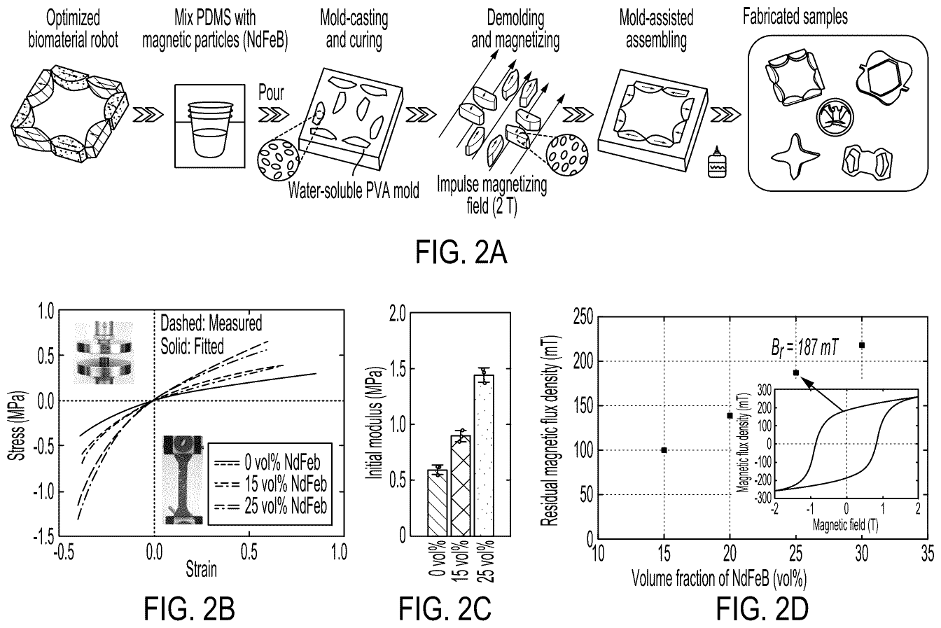

FIG. 2A illustrates the fabrication process of the optimized biomaterial robots through a molding and casting approach. Given the optimized design, the material is fabricated by mixing polydimethylsiloxane (PDMS) elastomer (with a base-to-agent ratio of 20:1) with NdFeB hard magnetic particles, and pouring the mixture into 3D-printed polyvinyl alcohol (PVA) molds for curing at 80° C. The material components are then removed from the molds and magnetized according to the designated magnetization directions. These individual components are then assembled into a single integrated robot. FIG. 2A showcases the library of fabricated samples utilized in this study.

To model the nonlinear magneto-mechanical performance of robots, the mechanical and magnetic properties of PDMS elastomers embedded with 0 vol %, 15 vol %, and 25 vol % NdFeB magnetic particles, respectively are characterized. As shown in FIG. 2B, the stress-strain curves demonstrate an increase in stiffness as the volume fraction of embedded magnetic particles increases. To characterize the nonlinear mechanical behavior of the materials, an I₁-based hyperelastic model is employed to fit the measured data (FIG. 9A-9F). FIG. 2C shows the initial modulus of the three elastomers. To capture the magnetic properties of the robots, the residual magnetic flux density Bᵣ is measured for the three elastomers. The results (FIG. 2D) reveal a nearly linear correlation between the measured Bᵣ and the volume fraction of magnetic particles. The inset presents the magnetization hysteresis loop for the sample with 25 vol % magnetic particles, resulting in a residual magnetic flux density of Bᵣ=187 mT. A higher Bᵣ can induce a larger actuated deformation, which is essential for generating sufficient mechanical stimuli to the tissue. Therefore, to ensure the robot's efficacy in generating the desired mechanical response while also considering manufacturability (as achieving a uniform mixing becomes more challenging with higher volume fractions of magnetic particles), the 25 vol % particle concentration is utilized for fabrication and subsequent experiments. These characterized results, aligning within a reasonable range compared to the literature, provide important insights into the mechanical behavior of the synthetic biomaterials, which are essential for the design, simulation, and experimental validation for the optimized robots.

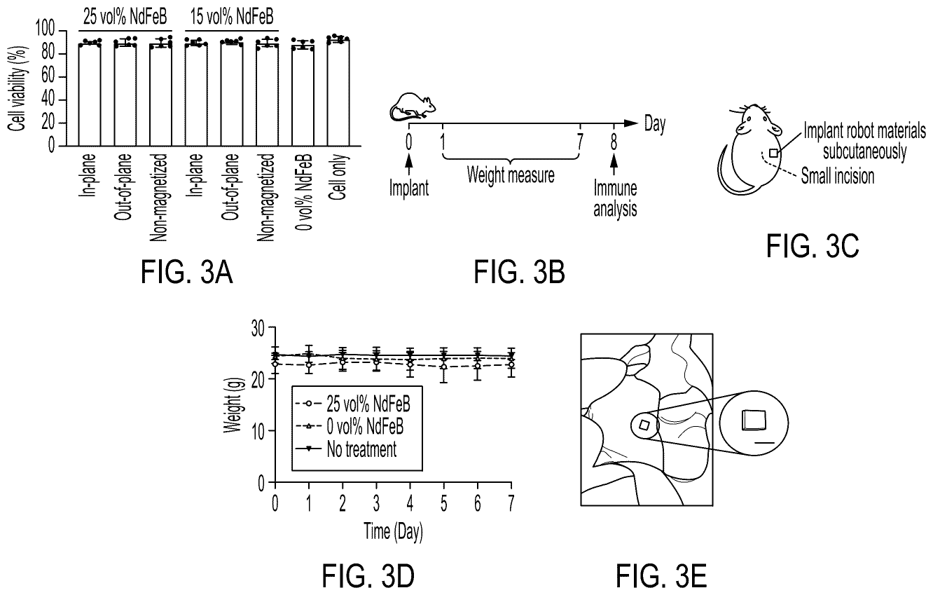

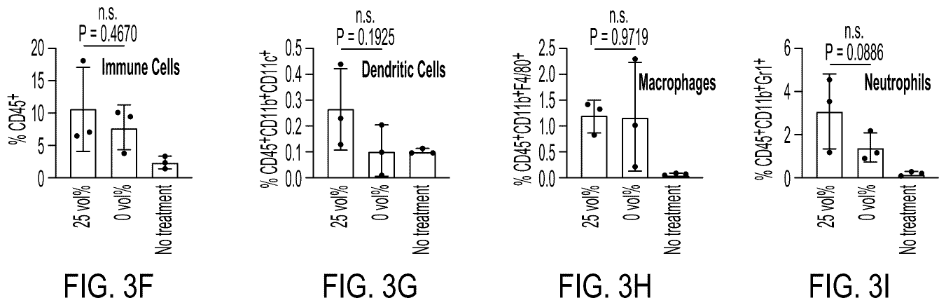

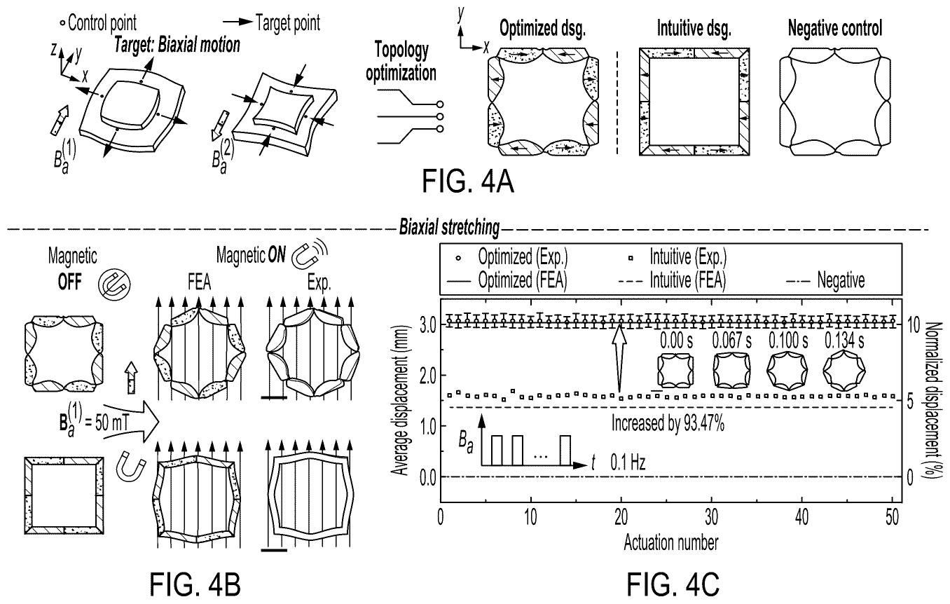

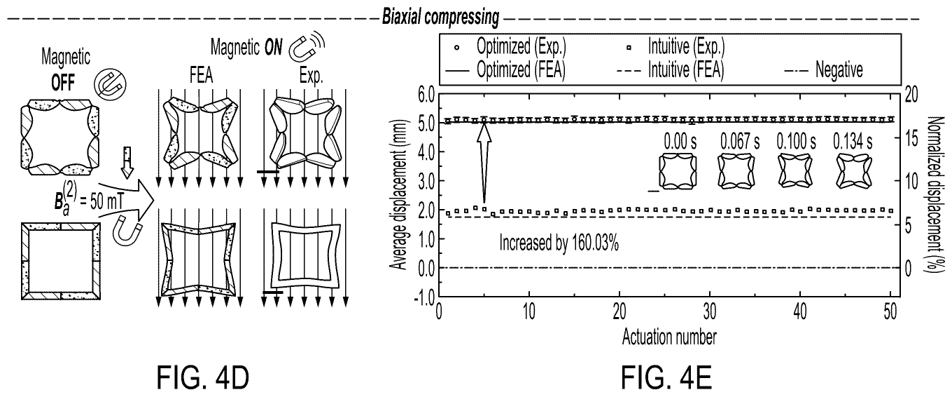

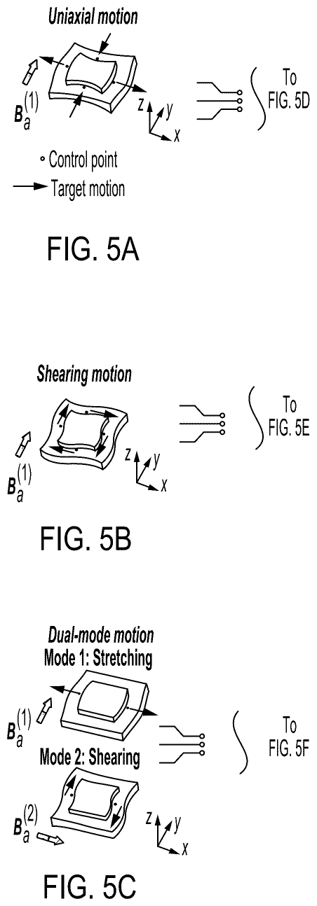

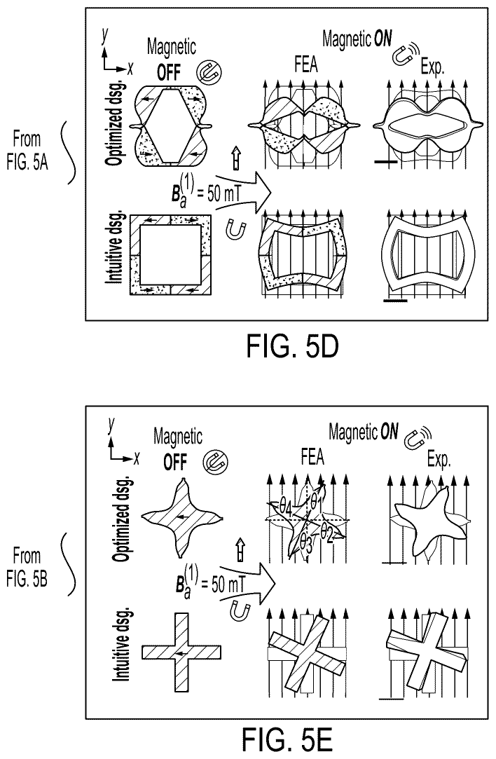

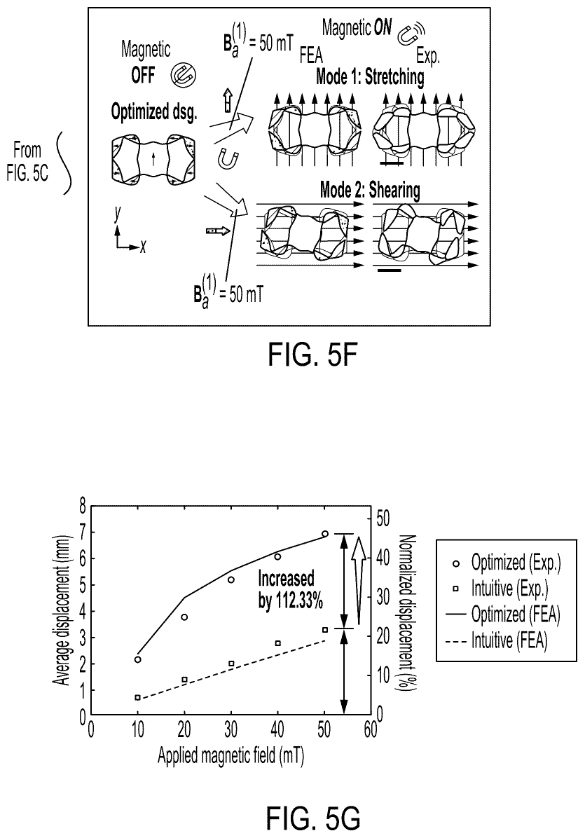

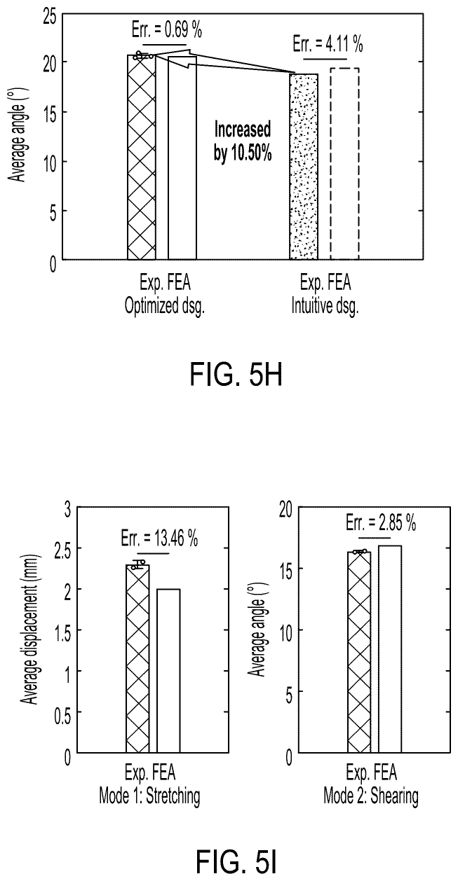

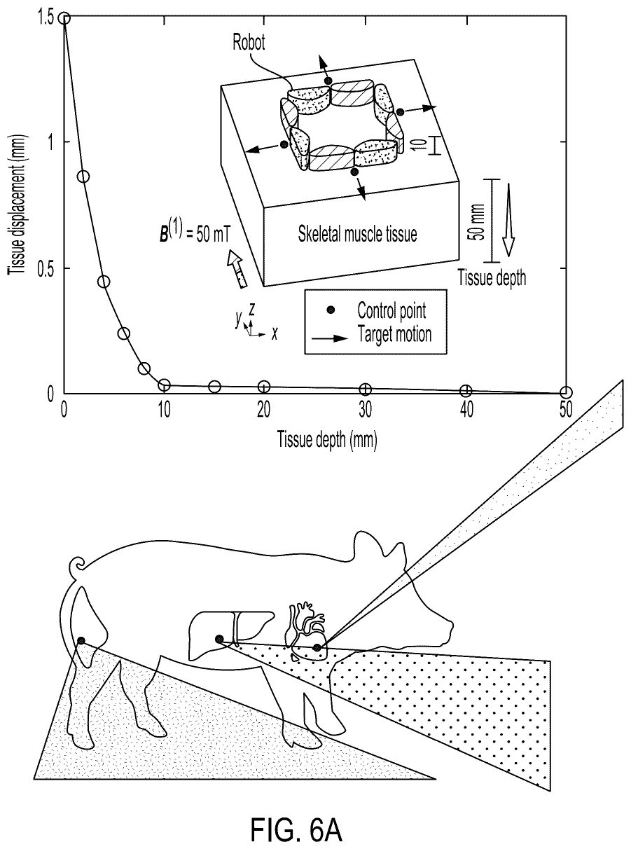

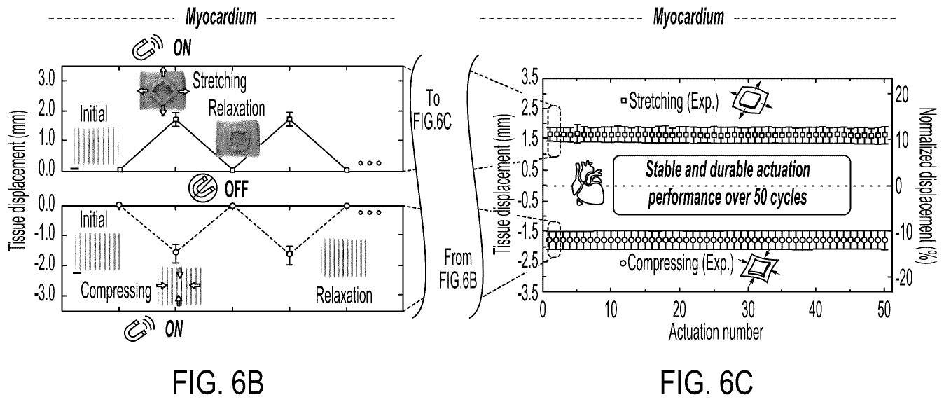

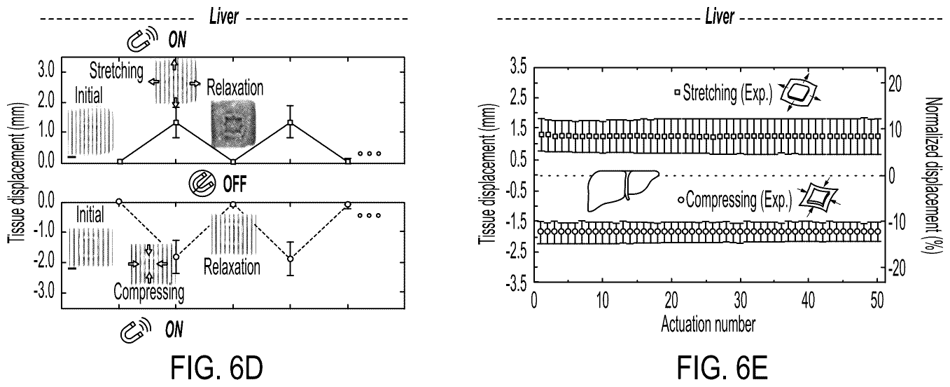

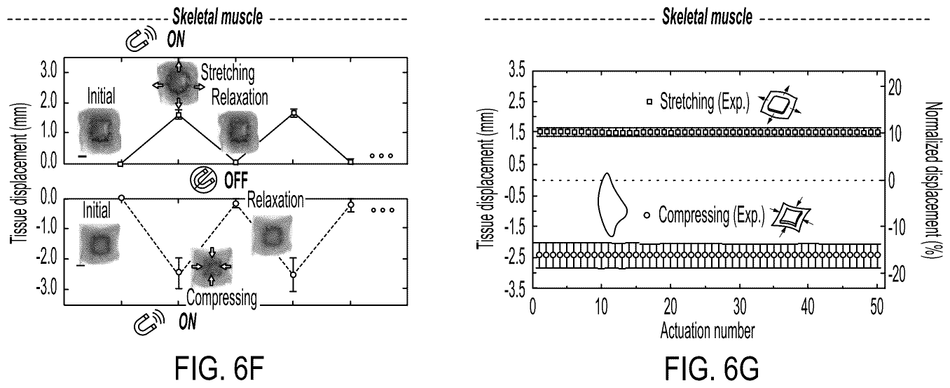

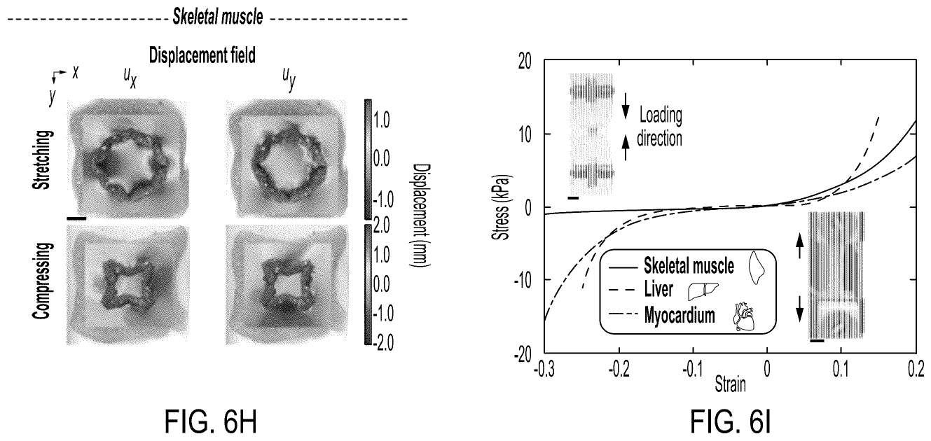

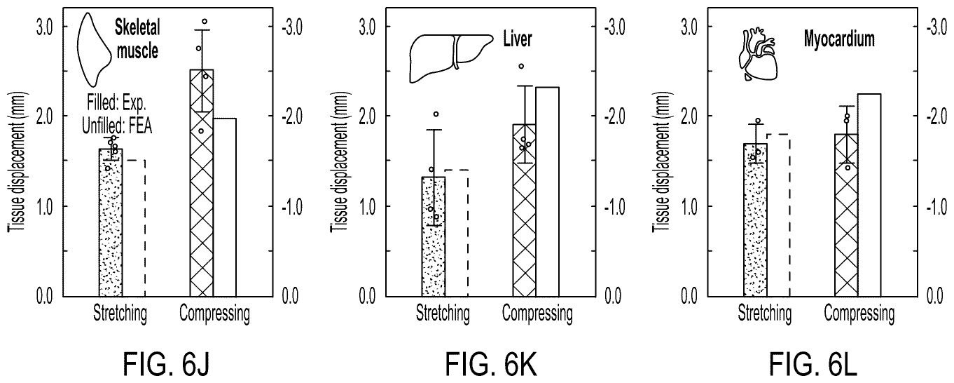

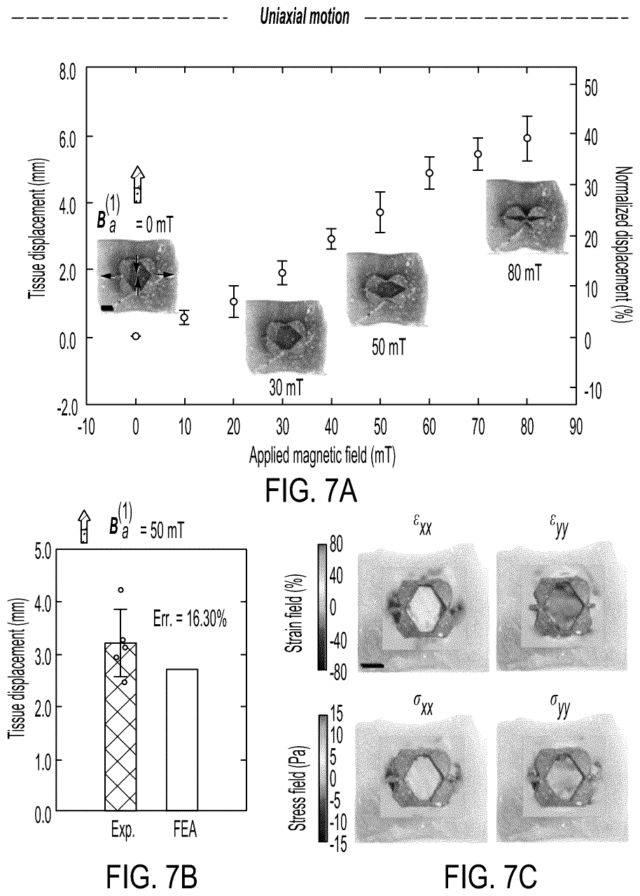

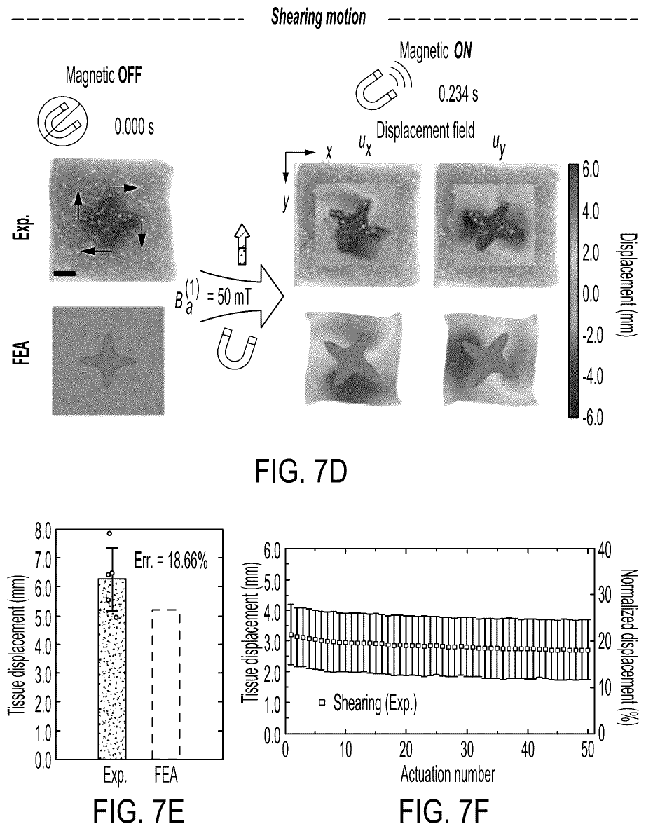

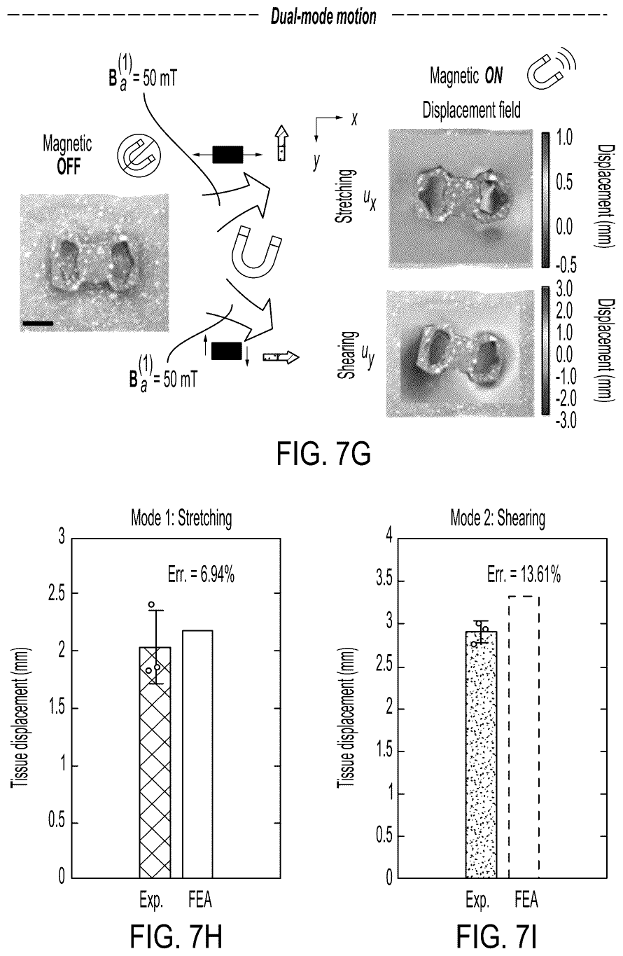

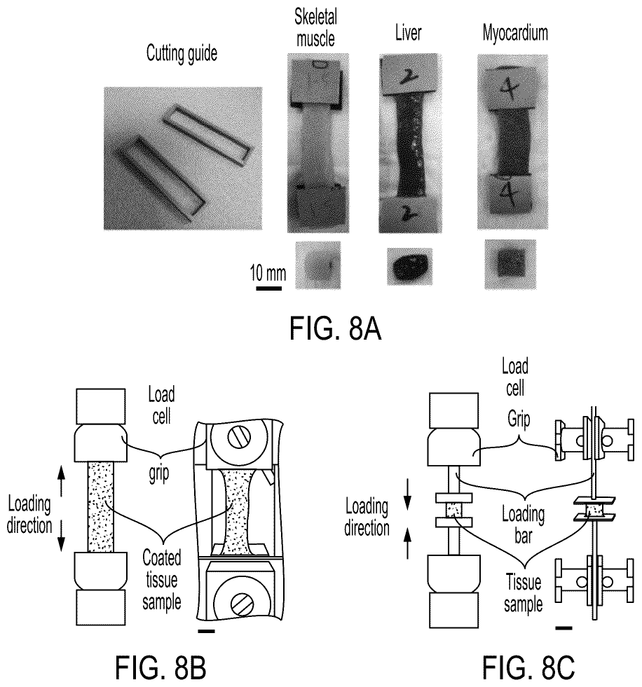

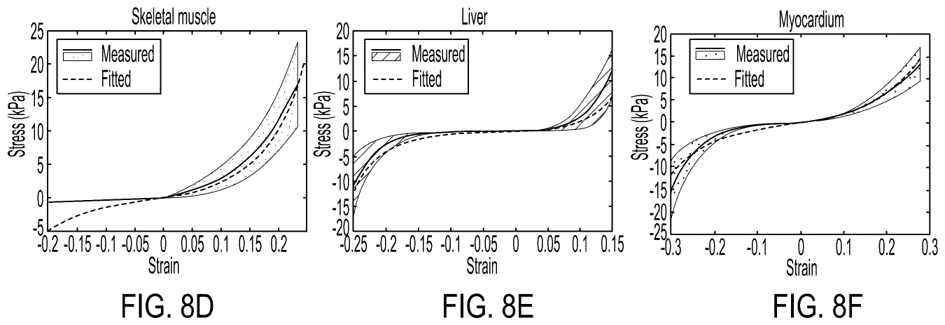

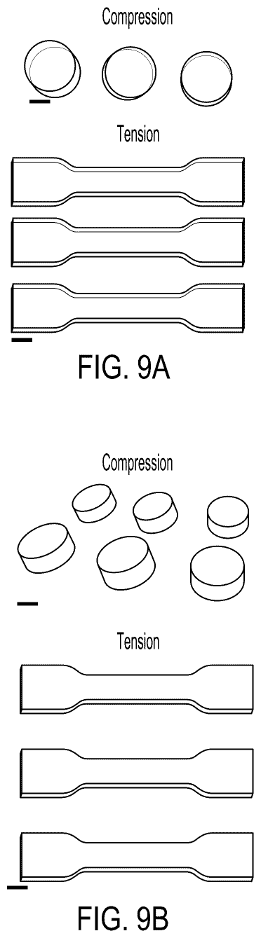

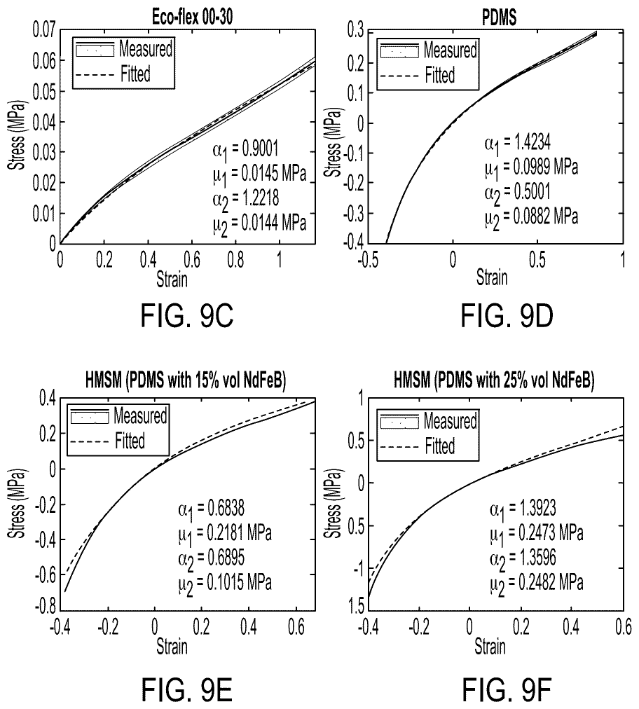

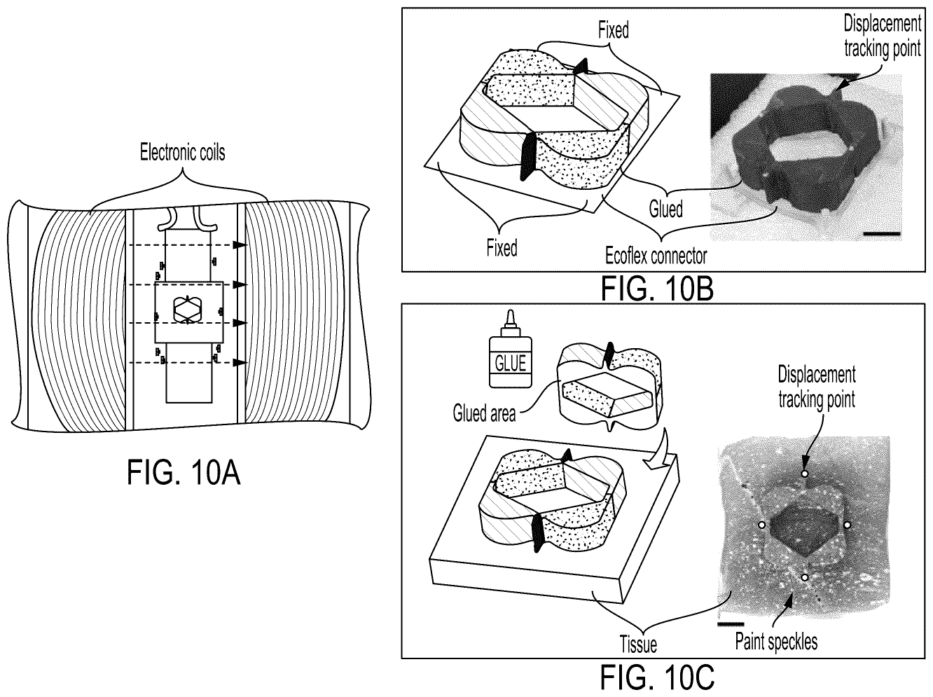

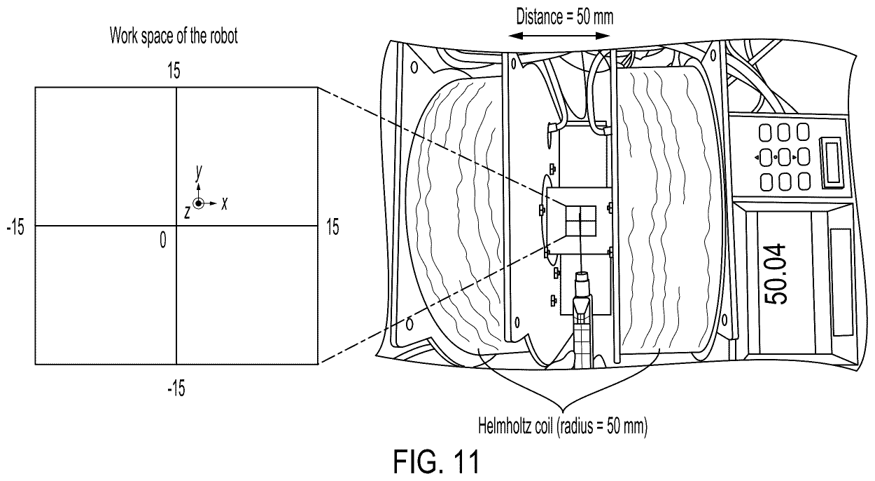

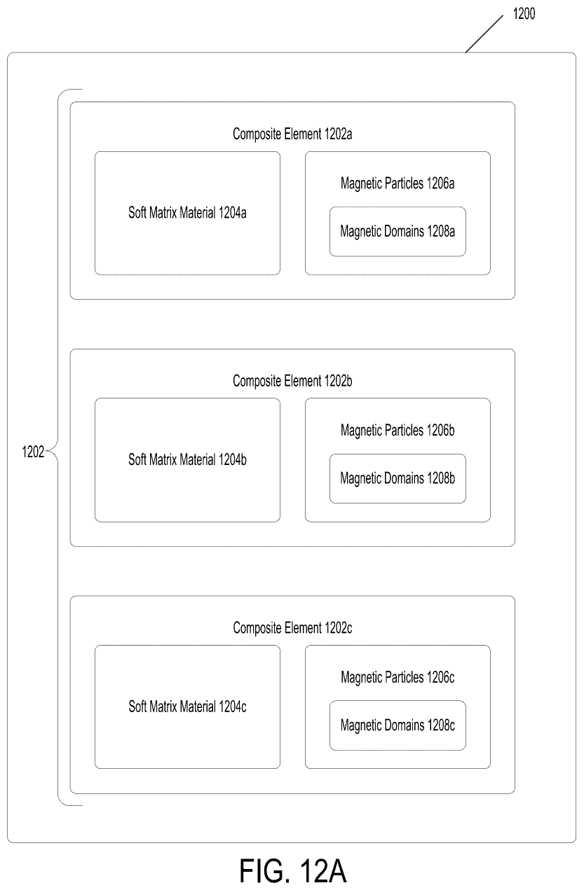

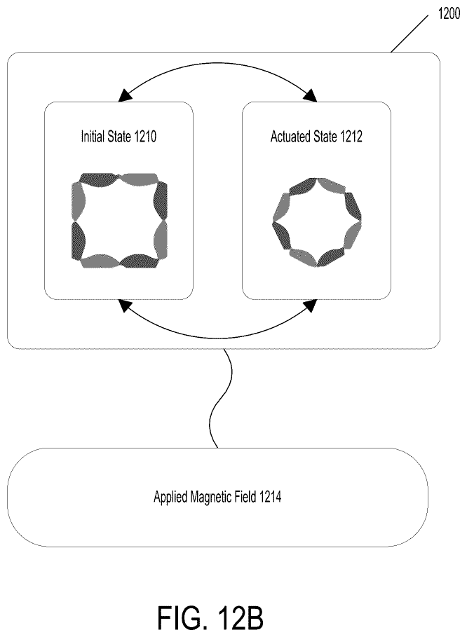

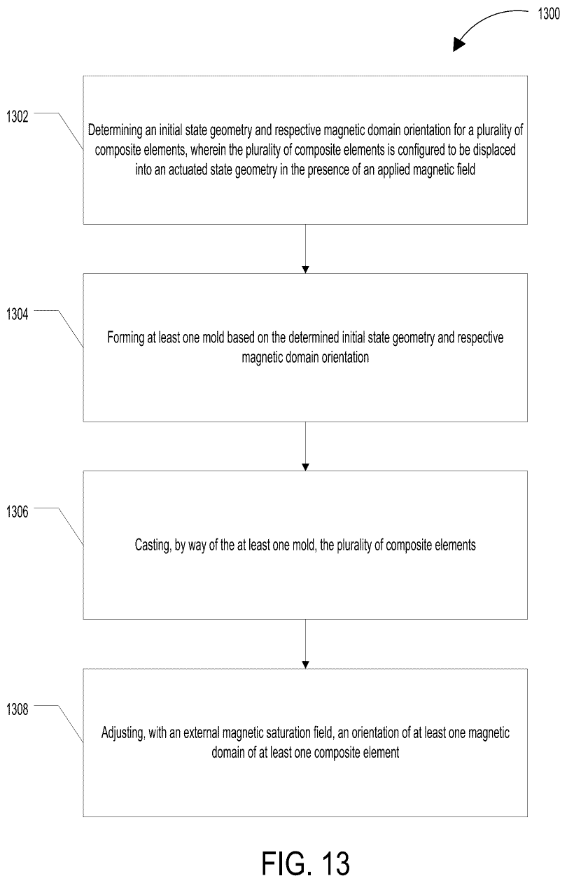

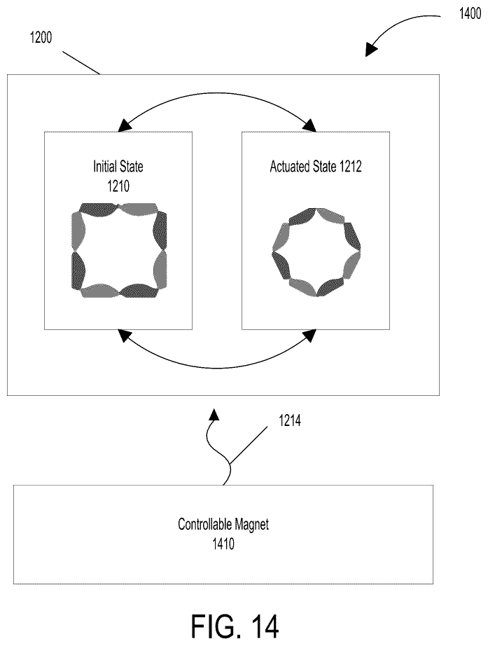

To evaluate the biocompatibility of the biomaterial in vitro, 3T3-L1 fibroblasts are cultured with the material of varied volume fractions (0%, 15%, and 25%) of magnetic particles and varied magnetization directions (in-plane, out-of-plane, and non-magnetized) for 72 hours. As shown in FIG. 3A, cells in all groups show good viability, and negligible differences are observed between the robot and non-treated groups, demonstrating the great biocompatibility of the robot biomaterials. The in vivo biocompatibility of the robot materials is then studied by subcutaneously implanting the materials into immunocompetent C57BL/6 mice and analyzing the associated immune responses (FIG. 3E). C57BL/6 mice were subcutaneously implanted with PDMS containing 25 vol % NdFeB magnetic particles or pure PDMS, followed by the analysis of immune cells at the implantation site after 8 days (FIGS. 3B and 3C). No sign of weight loss was observed (FIG. 3D). As expected, a small number of CD45⁺ immune cells were detected at the implantation site (FIG. 3F), most of which were neutrophils and macrophages that are known to first respond to external materials. Compared to pure PDMS, these robotic materials (PDMS with magnetic particles) showed negligible changes in the number of immune cells including CD11b⁺CD11c⁺ dendritic cells (FIG. 3G), CD11b⁺F4/80⁺ macrophages (FIG. 3H), and CD11b⁺Gr1⁺ neutrophils (FIG. 3I). This data demonstrated the negligible immunogenicity of the robot materials, and the feasibility of implanting a small size of magnetic robot for future mechanotherapy applications.

Wireless Magnetic Robots with Biaxial Motion

To validate the effectiveness of the optimized robots in providing target mechanical stimulation, performance tests on the wireless robots are conducted alone, without involving any tissue. FIG. 4A-4E shows the magneto-mechanical performance tests of robots programmed with target biaxial motions. FIG. 4A depicts the target tissue motions: biaxial stretching and compressing under two uniformly distributed external magnetic fields Bₐ⁽¹⁾ and Bₐ⁽²⁾, respectively, with opposite directions along the positive and negative y-axis, each having a magnitude of 50 mT. Taking into account the target tissue motion and mechanical properties of tissues and robots, the topology optimization approach produces one optimized design achieving the target biaxial motions, as depicted in FIG. 4A. To demonstrate the actuation performance of the optimized robots, a comparison case is included where the topology and magnetization directions are intuitively designed (see FIG. 4A, Intuitive dsg.). Additionally, robots that are non-magnetized (same topology as the optimized design) are also used as negative controls.

FIG. 4B illustrates the undeformed and actuated states of both the optimized and intuitive designs. The results indicate that both the optimized and intuitive designs successfully achieve the target biaxial stretching motions under magnetic actuation qualitatively but with different magnitudes of the actuation displacement. To evaluate the reproducibility of the optimized robots' performance, cyclic actuation is conducted on the three designs at a frequency of 0.1 Hz, with each magnetic on or off state lasting for 5 seconds. To quantitatively assess the actuation performance, the average displacement is evaluated by computing the mean of the actuated displacements at the control points. Additionally, for a more universally applicable representation of displacement, regardless of the robot's dimensions, the normalized displacement is introduced and is obtained by dividing the average displacement by the distance between the control point to the center of the robot. FIG. 4C plots both the numerically predicted and experimentally measured average and normalized displacements over 50 cycles of actuation, which demonstrates the excellent match between the actual displacements and simulation predictions over numerous rounds of actuation. In contrast, the negative control could not be actuated when exposed to the magnetic field due to the lack of magnetization. Notably, the optimization approach is able to increase the actuation performance of the biaxial stretching robots by 93.47%, in comparison with the intuitive design. Similarly, for the biaxial compressing robot, the optimized design is able to achieve the desired motion in the presence of magnetic field

$$( {B}_{a}^{( 2 )} )$$

and can increase the actuation performance by 160.030% compared to the intuitive design in a cyclic actuation test (FIGS. 4D and 4E). The subplots in FIGS. 4C and 4E illustrate the deformation process as it shifts from the magnetic OFF state to the magnetic ON state. It is evident that the robot undergoes rapid deformation under magnetic actuation, achieving this transformation in approximately 0.134 seconds.
Wireless Magnetic Robots with Uniaxial, Shearing, and Dual Motion Modes

FIGS. 5A, 5B, and 5C illustrate other principal target tissue motions: uniaxial, shearing, and dual-mode motions. For the uniaxial motion, the robot is designed to stretch in the x-direction and compress in the y-direction. For the shearing motion, the robot is designed to generate clockwise rotation. The dual-mode design refers to a more challenging case where stretching and shearing motions can be achieved through a single design under different magnetic fields. The optimized designs for these three cases are shown in FIGS. 5D-5F.

In the uniaxial motion case (FIGS. 5D, and 5G), the optimized design possesses four members with two magnetization directions. Note that this design also incorporates non-magnetized regions. The motion at the control points is induced by the magnetic torque generated by the four magnetized members. Inspired by the actuation mechanism in the optimized design, an intuitive design (FIG. 5D) is proposed for comparison. The simulation and experimental results indicate the target motions can be successfully achieved. The actuation performance is then evaluated by plotting the average and normalized displacement over the control points under varying magnitudes of |Bₐ⁽¹⁾|=10, 20, . . . , 50 mT (FIG. 5G). The results exhibit a consistent agreement between the simulation and experimental data. The actuation performance is increased with the increase of the applied magnetic field. Furthermore, the optimized design consistently outperforms the intuitive design across varying magnetic fields. It's important to note that this relationship holds true for other actuation modes as well.

In FIGS. 5E, and 5H, the performance test of the robot programmed with the shearing motion is presented. In this case, a cross-shaped topology connecting the four control points with uniform magnetization is generated by the optimization framework. Under the actuation of the external magnetic field, the robot rotates to align its magnetization with the applied magnetic field, resulting in shearing among the control points. Similarly, an intuitively designed robot is incorporated for comparison. The numerical and experimental demonstration figures for the undeformed and deformed states under |Bₐ⁽¹⁾|=50 mT are shown in FIG. 5E. The average rotational angle is evaluated and the comparison results are plotted in FIG. 5H, indicating a high agreement between the numerical predictions and experimental results, with an error of 0.69% and 4.11%. In this particular target motion setup, the optimized design exhibits only a relatively moderate improvement in actuation performance compared to the intuitive design, with an increase of 10.50%. This is due to the fact that the intuitive design proposed for this specific case is close to the optimized solution.

When considering the dual-mode motion (FIGS. 5F and 5I), achieving precise and simultaneous control of two different motions with a single design based solely on intuition poses significant challenges. However, by leveraging the topology optimization framework, the design depicted in FIG. 5F is obtained. Notably, the stretching motion primarily originates from the movement generated by the eight surrounding members positioned on the left and right sides adjacent to the central part of the design. Conversely, the shearing motion is predominantly facilitated by the rotation of the central part of the design. To assess the performance of the design, the average displacement at the two control points is compared for the stretching mode and the average rotating angle for the shearing mode, as illustrated in FIG. 5I. The comparison between the numerical and experimental results reveals an error of 13.46% and 2.85% for the stretching and shearing modes, respectively.

The aforementioned performance tests validate that, when provided with a target tissue motion, the proposed design framework has the ability to automatically generate biomaterials exhibiting superior actuation performance compared to designs obtained solely from intuitive approaches. The experimental validation confirms the replicability of the fabricated designs. The establishment of this design framework holds great promise for the creation of mechanotherapy soft robots capable of accommodating diverse modes of loading, taking into account the unique properties of individual tissues.

### Wireless Magnetic Robots-Induced Biaxial Motion of Tissues

To demonstrate the capability of the optimized robots in generating and delivering mechanical stimulation to the tissue, ex vivo testing of the biaxial robots on different types of tissues, including porcine skeletal muscle, liver, and myocardium tissues is conducted (FIG. 6A-6L).

Initially, a 3D numerical simulation is conducted to explore the penetration depth of deformation propagating into the tissue bulk (FIG. 6A). Specifically, the biaxial stretching robot implanted on a bulky porcine skeletal muscle tissue with a depth of 50 mm is considered. Subsequently, tissue displacement is calculated as the mean of actuated displacements across four control points at different depths within the tissue bulk, employing a magnetic actuation of 50 mT. It can be seen that despite a reduction in tissue deformation with increasing depth, displacement remains observable within the 0-10 mm depth range. For the following ex vivo tests, tissue samples with an approximate depth of 5-10 mm are adopted. Optimized robots are attached to the surface of tissues via the super glue. While super glue is used as an adhesive between soft robots and tissues in this study for demonstration purposes, other types of bioadhesives such as COSEAL, cyanoacrylates, and tough hydrogel adhesives may be used to ensure a high adhesion strength and good biocompatibility. These bioadhesives have been widely used for in vivo hemostatic, tissue repair, and imaging applications. To enable the real-time monitoring of displacement via digital image correlation (DIC), speckle patterns are sprayed onto the surface of tissues (FIG. 10A-10C). Under the actuation of the magnetic field, the robot's movement leads to the deformation of the underlying tissue.

To assess the stability of the actuation performance in stimulating tissue deformation, a cyclic loading strategy is employed for the ex vivo test at an actuation rate of 0.1 Hz, ensuring sufficient deformation and recovery processes for the tissue and robot. Experimental measurements of average displacements at control points in three types of tissues (myocardium, liver, and skeletal muscle) during 2 cycles of magnetic activation and deactivation for biaxial stretching and compressing are presented in FIGS. 6B, 6D, and 6F, respectively. Insets accompanying the figure display photos of tissues during the actuation. Note that slight residual displacements are observed in the relaxing state when the magnetic field is off, attributed to the viscoelasticity of the bio-tissues. In FIGS. 6C, 6E, and 6G, the average tissue displacements and their corresponding normalized values over 50 consecutive actuation cycles are illustrated. These normalized displacements are computed by dividing the average tissue displacements by the distance between the control points and the center of the robot. It can be seen that for all three types of tissues, the actuation performance can be sufficiently maintained after 50 cycles of actuation. FIG. 6H illustrates the experimentally measured displacement field of skeletal muscle tissue during biaxial stretching and compressing motions, acquired through DIC analysis. This presentation further confirms the successful attainment of the target tissue deformations.

To capture the hierarchical interaction between the biological tissue and robots and predict tissue deformation, the nonlinear mechanical properties of the tissues are characterized and modeled. From the experimentally measured stress-strain curves (FIG. 6I), it can be seen the tissues exhibit a significant degree of nonlinearity. Given the inherent large variability in biological tissue properties, ensuring data reliability is crucial. In this context, it is demonstrated that the measured data falls within a reasonable range when compared to values reported in the literature. In this work, a hyperelastic Ogden model is employed to characterize the nonlinear mechanical properties of these three types of tissues (see FIG. 8A-8F for detailed information on the tissue characterization). To evaluate the accuracy of the optimization and numerical modeling approach in capturing the interaction between the tissues and the robots, the average displacements at the control points are quantitatively compared under 1-time actuation for these three types of tissues shown in FIGS. 6J, 6K, and 6L. It can be seen the finite element analysis (FEA) results lie in the reasonable range of the experimental results. For the biaxial stretching case, comparable deformations are observed in skeletal muscle and myocardium tissues, while the liver tissue displays unexpectedly smallest actuation deformation. This observation is rationalized by the characterization data (FIG. 6I), which reveals that despite its lower initial modulus, the liver undergoes premature stiffening relative to the other tissues. Consequently, it exhibits minimal actuation displacement under the regime of large deformation. Regarding biaxial compression, the liver and myocardium tissues exhibit comparable deformation levels, whereas the skeletal muscle tissue displays the greatest experimentally measured actuation displacement. This is attributed to the skeletal muscle's lower stiffness under compressive strain (FIG. 6I). It is noteworthy that the significant biaxial compressive deformation in skeletal muscle tissue is not adequately predicted by FEA due to limitations in the Ogden model's ability to capture tension-compression asymmetry in skeletal muscle. Addressing this limitation requires the utilization of more refined models in future investigations.

The above findings provide compelling evidence of the potential of the optimized wireless robots to proficiently transmit mechanical stimuli and induce biaxial stretching and compressing deformations of diverse biological tissues. This indicates a promising direction for future research and development, leveraging the design framework to create mechanotherapy soft robots that are specifically tailored to the unique properties and requirements of individual tissues. By incorporating tissue-specific considerations into the design process, these robots hold the prospect of unlocking new avenues for targeted therapeutic interventions, optimizing the delivery of mechanical stimulation, and maximizing the therapeutic benefits across a wide range of tissue types.

### Wireless Magnetic Robots-Induced Uniaxial Motion of Skeletal Muscles

Skeletal muscle has been an active target of research for mechanical stimulation and mechanotherapy. In addition to biaxial motion, the capability of the wireless magnetic robot to induce the uniaxial motion of underlying porcine skeletal muscles is evaluated (FIGS. 7A-7C). As expected, the uniaxial wireless robots are able to stretch the porcine skeletal muscle tissue in the horizontal direction while compressing the tissue in the vertical direction. The average and normalized tissue displacements at four control points increases with the magnitude of the magnetic field (|B⁽¹⁾|=0, 10, 20, . . . , 80 mT) (FIG. 7A), demonstrating that varying the external applied magnetic field allows for control of different levels of actuation. FIG. 7B compares the experimental (with n=5 independent samples) and FEA results under |B⁽¹⁾|=50 mT. FIG. 7C depicts the experimentally measured strain fields acquired through the DIC analysis for skeletal muscle tissue deformation. It can be seen that under the programmed uniaxial motion of the robot, the inner middle part of the tissue sample is stretched in the horizontal while being compressed in the vertical direction. Conversely, the outer small regions surrounding the left and right control points undergo compression in the horizontal direction, while the outer regions surrounding the top and bottom control points undergo stretching in the vertical direction, driven by the robot's movement. To evaluate the generated stress on the tissue sample, the stress field is numerically calculated based on the characterized stress-strain relationship (FIG. 6I) of the skeletal muscle tissue as shown in FIG. 7C.

### Wireless Magnetic Robots-Induced Shearing Motion of Skeletal Muscles

Next it was studied whether the wireless robots optimized for a shearing motion mode can induce the designed mechanical stimulation of skeletal muscles (FIGS. 7D-7F). In the presence of a magnetic field (50 mT), the optimized robot, together with the underlying skeletal muscle tissue, show the expected clockwise rotation (FIG. 7D). In FIG. 7D, the experimental and numerical displacement fields during the actuation are plotted. It can be seen the top and bottom control points of the tissue experience horizontal shearing motion while the left and right control points experience vertical shearing motion satisfying the design target. The FEA results can successfully predict the deformation trend of the skeletal muscle tissue. FIG. 7E plots the average shearing displacement comparison at the control points between the numerical and experimental results for the 1-cycle actuation. The sustainability of the shearing motion robots is further evaluated by applying numerous cyclic actuations. The average and normalized shearing displacements over the last 50 cycles of actuation are plotted in FIG. 7F for reference. The results indicate that the observed displacements in the subsequent cycles exhibit a reduction compared to those in the initial cycle. This decline can be attributed to the inherent viscoelastic properties of the tissue. Nonetheless, even after multiple cycles of loadings, a substantial tissue displacement of approximately 3 mm (20% normalized displacement) can still be achieved.

### Wireless Magnetic Robots-Induced Dual-Mode Motion of Skeletal Muscles

FIGS. 7G-7I show the experimental results of the dual-mode motion robots on the skeletal muscle tissue. In the stretching mode, where only horizontal deformation is controlled as the target, the corresponding uₓ displacement field is displayed in the top figure of FIG. 7G. Similarly, in the shearing mode, where only vertical deformation is controlled, the u_{y} displacement field is shown in the bottom figure of FIG. 7G. It can be observed under the vertical magnetic field B⁽¹⁾ (50 mT), the robot can induce the stretching movement of the underlying tissue surrounding the left and right control points. The average tissue displacement is measured to be 2.04 mm, resulting in an error of 6.94% compared to the predicted value (FIG. 7H). When subjected to the horizontal magnetic field B⁽²⁾ₐ instead, the robot is capable of generating the shearing motion of the tissue at the two control points, with an average displacement of 2.90 mm. This induces an error of 13.61% compared to the numerical result (FIG. 7I). These experiments demonstrate that the optimized robots programmed with different target motions can successfully transfer the mechanical stimulation to the underlying tissues and induce the deformation of tissues in a predictable manner.

To summarize, wireless magneto-active soft robots have been developed that can be remotely actuated by magnetic fields to exhibit various types of motions (biaxial stretching and compressing, uniaxial motion, shearing, and dual-mode motions) and induce the deformation of different tissues in a precisely programmable and predictable manner. An inverse design paradigm is employed to create a diverse set of topology-optimized wireless magneto-active soft robots, each tailored for specific principal actuation modes. Then, a biocompatible fabrication protocol is established using a mold-casting approach. Through this approach, the robots can be manufactured at various scales while ensuring reproducibility. These soft robots show good biocompatibility through in vitro and in vivo tests on mice. Finally, the ex vivo performance test is conducted on different types of porcine tissues to validate the effectiveness and precision of the fabricated robot designs. The experimental results confirm that the magneto-active robots are capable of transferring controlled motion to the underlying tissue. The numerical results yield reasonable predictions on the deformations of different types of tissues under different actuation modes.

Overall, this study highlights the effectiveness of magneto-active robots in stimulating various modes of deformations in bio-tissues in a controllable and programmable manner, which has great potential for facilitating both fundamental mechanotransduction studies and the development of new-generation mechanotherapy for tissue repair. Moving forward, the in vivo application of the wireless magnetic robots in animal models of tissue injury will be explored. While increasing evidence indicated the promise of cyclic mechanical loading to regulate local immune responses and facilitate tissue restoration, the optimal mechanical force, tissue deformation, and cycles of loading remain unknown. These parameters will be taken into consideration for the design of animal studies. In cases when the deformation of the robot and underlying tissue could be limited due to the presence of friction between tissue layers, the mechanical forces can be amplified by adjusting the percentages of magnetic particles in the soft robot and/or the external magnetic field. Lastly, another challenge lies in visualizing the in vivo deformation of hard magnetic soft robots. Imaging modalities, such as low-dose ultrasound x-ray imaging, could be explored as potential solutions to address this issue.

### Example Materials and Instrumentation

Polydimethylsiloxane (Dow Sylgard 184 Kit), Fetal Bovine Serum (FBS), Calcein AM, and Ethidium Homodimer-1 were purchased from Thermofisher (Waltham, MA, USA). NdFeB particles with an average size of 25 μm (MQP-B+-20441) were purchased from Magnequench (Indianapolis, IN, USA). Polyvinyl Alcohol (PVA) was purchased from Prusa Research (Prague, Czech Republic). Sil-poxy adhesive and Ecoflex 00-30 were purchased from Smooth-On Inc. (Macungie, PA, USA). Porcine tissues were purchased from Sierra for Medical Science (Whittier, CA, USA). The magnetizer (IM-10-30) was purchased from ASC Scientific (Narragansett, RI, USA). Helmholtz coils were purchased from Woodruff Scientific (Santa Fe, NM, USA). Photos and videos of materials were taken with a SONY α7R camera. Deformations of robots and tissues were tracked via digital image correlation (DIC) and Tracker. FACS analyses were collected on Attune NxT flow cytometers and analyzed on FCS Express v6 and v7. Mechanical tests of robots and tissues were performed on the Instron 68TM-30.

### Example Cell Lines and Animals

3T3-L1 cell line was purchased from American Type Culture Collection (Manassas, VA, USA). Cells were cultured in RPMI 1640 containing 10% FBS, and 100 units/mL Penicillin/streptomycin at 37° C. in 5% CO₂ humidified air. Female C57BL/6 mice were purchased from Jackson Laboratory (Bar Harbor, ME, USA). Feed and water were available ad libitum. Artificial light was provided in a 12/12 hour cycle. All procedures involving animals were done in compliance with National Institutes of Health and Institutional guidelines with approval from the Institutional Animal Care and Use Committee at the University of Illinois at Urbana-Champaign.

### Example Fabrication of Robots

Polydimethylsiloxane and NdFeB particles were mixed thoroughly for 15 minutes, followed by defoaming for 1 hour to eliminate any trapped air bubbles. For the curing process, PVA molds with various geometries were 3D printed and used. Each geometry corresponds to an individual component of the optimized design. The mixture was then cured at 80° C. for 2 hours. After curing and demolding, the individual components were magnetized according to the desired magnetization directions using a 2 T impulse magnetic field (IM-10-30), as recommended by the manufacturer's datasheet, ensuring it is deemed sufficient to attain ≥95% magnetic saturation of the NdFeB particles. Subsequently, the different parts were bonded together in a complete PVA mold using Sil-poxy adhesive. Once the adhesive is fully cured at room temperature, the integrated robots were removed from the complete mold. The size of the robot can be simply scaled to any dimension. In this study, a size of 30 mm (length)×30 mm (width)×10 mm (thickness) design domain of the robot was used.

### Example Magnetic Actuation System

A pair of Helmholtz coils with the radius and spacing of 50 mm was utilized to generate a nearly uniform magnetic field in alignment with the computational assumption. The direction and magnitude of the generated magnetic field were measured by a Gauss meter (PCE-MFM 4000). The Helmholtz coil was connected to a programmable power supply. The magnitude of the generated magnetic field was controlled to be consistent with the simulation parameters by adjusting the supplied current. The measurement setup of the magnetic field is shown in FIG. 11. With respect to the center of the reference system defined in FIG. 11, the robot experiments were conducted within a 30 mm-wide workspace along the x and y axes. Prior to each experiment, precise calibration of the robot's location was performed to ensure it remained within the space of uniform and consistent magnetic fields.

### Example Performance Test of Robots

To conduct the performance test of the manufactured robots, the bottom surface of the robot was bonded to a thin connector (see FIG. 10A-10C) made of Ecoflex 00-30 using the Sil-poxy adhesive. The experiment setup for testing the performance of robots is illustrated in FIG. 10A-10C. A pair of Helmholtz coils was used to generate a nearly uniform magnetic field. The robot was placed at the center of the coils. To fix the robot, slender bars were inserted into the bottom connector at its four corners and affixed to a foam support. The robot was elevated slightly creating a small gap to prevent friction during its movement under actuation. A camera (SONY α7R) was positioned appropriately to record the videos. The displacements of the control points on the robots were then obtained by post-processing the video using Matlab and Tracker.

### Example Actuation of Porcine Tissues

For the ex vivo actuation and deformation experiments on porcine liver, myocardium, and muscle tissues (see FIG. 10A-10C), the tissue samples were prepared in a nearly rectangular shape. The robot was bonded on the top surface of the tissue by super glue. The tissue surface was delicately dried first, and then the super glue (Loctite 1365882, Amazon) was applied to the bottom of the soft robots. Subsequently, the robots were applied to the tissues, and any surplus glue residue was removed from the tissue. To ensure secure adhesion, gentle pressure was applied for a duration of 2 minutes. The displacements of the tissue surrounding the control points were video recorded and tracked by Tracker. To analyze the full displacement field of the tissue, speckle patterns were sprayed onto the surface of the tissue. The recorded videos were then post-processed by Matlab and analyzed using Ncorr, a two-dimensional DIC program. The displacement fields were created by comparing the images of the tissue samples before and after the actuation. The areas covered by the robots were excluded from the analysis. Note that since the magnetic actuation is quite fast and the induced tissue strain is relatively larger, we added intermediate actuation images and enabled the high strain and backward analysis to make the DIC work effectively.

### Example Mechanical Characterization of Robot Materials

The mechanical properties of the robotic materials were characterized by fitting the parameters in the constitutive model to the stress-strain relationships obtained from testing dog-bone specimens according to standard in uniaxial tension, and cylinder specimens according to standard in compression (FIG. 9A-9F). For each group of materials (20:1 PDMS elastomer with 0 vol %, 15 vol %, and 25 vol % NdFeB magnetic particles), three samples for tension or compression were tested on a loading machine (Instron 68TM-30) with a 5.0 mm/min overhead speed. To accurately simulate the behavior in the performance test (FIGS. 4A-4E and 5A-5I), the mechanical property of the Ecoflex connector was also tested and characterized using the I₁-based hyperelastic model by performing the uniaxial tension test using dogbone samples. The residual magnetic flux densities of the material were measured using a vibrating-sample magnetometer (Quantum Design MPMS3).

### Example In Vitro Biocompatibility Test

The biocompatibility of the robotic materials was assessed in seven different groups: (1) In-plane magnetized 25 vol % NdFeB PDMS (n=6), (2) Out-of-plane magnetized 25 vol % NdFeB PDMS (n=6), (3) Non-magnetized 25 vol % NdFeB PDMS (n=6), (4) In-plane magnetized 15 vol % NdFeB PDMS (n=6), (5) Out-of-plane magnetized 15 vol % NdFeB PDMS (n=6), (6) Non-magnetized 15 vol % NdFeB PDMS (n=6), and (7) pure PDMS (n=6). Circular disks of materials with a diameter of 10 mm and a thickness of 3 mm were placed in 24-well plates, subjected to UV sterilization for 1 hour, and washed with PBS prior to use. 3T3-L1 cells from American Type Culture Collection (Manassas, VA, USA) were then placed on top of the materials and cultured in DMEM containing 10% FBS, 100 units/mL Penicillin G and 100 μg/mL streptomycin at 37° C. for 48 h in 5% CO₂. To assess cell viability, live and dead cells were stained with Calcein AM and Ethidium Homodimer-1, respectively, and analyzed on a flow cytometer.

### Example In Vivo Biocompatibility Test

C57BL/6 mice were divided into three groups: (1) In-plane magnetized 25 vol % NdFeB PDMS (n=3), (2) pure PDMS (n=3), and (3) No treatment (n=3). On day 0, a small incision was cut on the back skin of immunocompetent C57BL/6 mice. Materials were then placed in the subcutaneous pocket, followed by suture closing. The body weight of mice was closely monitored after the implantation. On day 8, tissues surrounding the implants were harvested, and treated with collagenase IV (0.5 mg/mL) for 45 minutes. Following the collagenase IV treatment, tissues were disrupted using a syringe plunger to release cells. These released cells were then collected, washed, and subjected to staining for flow cytometry analysis. For the analysis of immune cell populations, cells were stained with APC-conjugated anti-CD45, PE-conjugated anti-CD11b, PE/Cy7-conjugated anti-CD11c, Alexa Fluor 700-conjugated anti-Ly-6G/Ly-6C, PerCP/Cy5.5-conjugated anti-F4/80.

### Example Mechanical Characterization of Porcine Tissues

For the characterization of porcine biceps femoris muscle tissue, liver, and myocardium tissues, the tissue samples were cut into strips and cubics for the uniaxial tension and compression tests, respectively. The tests were performed at room temperature using a loading machine (Instron 68TM-30) at a strain rate of 0.5%/s. Detailed information is provided in FIG. 8A-8F.

### Example Topology Optimization Approach

Utilizing a 2D topology optimization framework tailored for magnetic-actuated materials, the in-plane geometry and remnant magnetization distribution of biomaterial robots within a tissue environment is optimized. The externally applied magnetic field is considered to be a uniform vector, with a magnitude of 50 mT. To parameterize the entire design, two sets of design variables are introduced. The matrix material distribution, representing geometry, is parameterized by the physical density variable ρ̅. Here, ρ̅e=1 designates a solid element e, while ρ̅e=0 designates a void. Concurrently, a set of magnetization indicator variable vectors

$${\overline{m}}_{e}^{( j )} , j = 1 , … , {N}_{m}$$

is employed to express the actual residual magnetic flux density B_{r,e}. Formally, the residual magnetic flux density in element e is defined as

$${B}_{r , e} = {\sum }_{j = 1}^{{N}_{m}} {( {\overline{m}}_{e}^{( j )} )}^{{p}_{m}} {B}_{r}^{( j )}$$

where

$${\overline{m}}_{e}^{( j )} = 1$$

indicates the selection of the jth candidate residual magnetic flux density

$${B}_{r}^{( j )} ,$$

while

$${\overline{m}}_{e}^{( j )} = 0$$

signifies that the jth candidate residual magnetic flux density

$${B}_{r}^{( j )}$$

is not chosen. To promote the convergence of the physical magnetization variables

$${\overline{m}}_{e}^{( j )}$$

to either 1 or 0, a penalization power, denoted as pₘ is introduced.

To describe the nonlinear magneto-mechanical performance of magnetic robots and tissues, an interpolation of the energy function is presented based on the physical variables ρ̅ and

$${\overline{m}}_{e}^{( j )} ,$$

where j=1, . . . , Nₘ. The expression for the interpolated element-wise energy

$${W}_{e}^{( ℓ )}$$

is provided by the following equation:

$${W}_{e}^{( ℓ )} ( {\overline{ρ}}_{e} , {\overline{m}}_{e}^{( 1 )} , ... , {\overline{m}}_{e}^{( {N}_{m} )} , {u}_{e}^{( ℓ )} ) = [ ϵ + ( 1 - ϵ ) {( {\overline{ρ}}_{e} )}^{{p}_{ρ}} ] {W}_{E , e} ( {u}_{e}^{( ℓ )} ) + {( {\overline{ρ}}_{e} )}^{{p}_{ρ}} {W}_{M , e} ( {u}_{e}^{( ℓ )} , {B}_{r , e} ( {\overline{m}}_{e}^{( 1 )} , ... , {\overline{m}}_{e}^{( {N}_{m} )} ) ) + {W}_{T , e} ( {u}_{e}^{( ℓ )} ) ,$$

where

$${u}_{e}^{( ℓ )}$$

represents the displacement vector in element e under the lth applied magnetic field

$${B}_{a}^{( l )} ,$$

and ϵ=10⁻⁵ serves as a small value to prevent singular stiffness. The penalization parameters p_{ρ}, associated with both energies, are employed to penalize both elastic-stored energy and magnetic free energy, promoting a discrete design. The expressions W_{E,e} and W_{M,e} represent the elastic energy and magnetic energy associated with the magnetic robot, respectively. The term W_{T,e} corresponds to the stored energy of underlying tissues, explicitly considered within the optimization framework.

Having introduced the design space parameterization and free-energy interpolation schemes, the topology optimization formulation for generating magneto-active bio-robots is outlined. The mesh Ωₕ consists of Nₑ elements and Nₙ nodes. The objective of the topology optimization is to maximize tissue displacements at control points while adhering to constraints and ensuring nested equilibrium. Formally, the topology optimization problem is expressed as follows:

$${min}_{ρ , {ξ}^{( 1 )} , ... , {ξ}^{( {N}_{m} )}} {max}_{\begin{matrix}ℓ ∈ \{ 1 , ... , {N}_{ℓ} \} \\ α ∈ \{ 1 , ... , {N}_{α}^{( ℓ )} \}\end{matrix}} {u}_{α}^{( ℓ )} ,$$

$$s . t . : \frac{{v}^{T} \overline{ρ}}{\vert {Ω}_{h} \vert} \leq {v}_{max} ,$$

$${σ}_{0}^{( ℓ )} \leq {σ}_{max}^{( ℓ )} , ℓ = 1 , ... , {N}_{ℓ} ,$$

$$R ( \overline{ρ} , {\overline{m}}_{e}^{( 1 )} , ... , {\overline{m}}_{e}^{( j )} , {u}^{( ℓ )} ) = 0 , ℓ = 1 , ... , {N}_{ℓ} ,$$

$$0 \leq ρ \leq 1 ,$$

$$0 \leq {ξ}^{( j )} \leq 1 , j = 1 , ... , {N}_{m} ,$$

where

$${u}_{e}^{( ℓ )}$$

represents the actual displacement at the ath control degree of freedom (DOF) of the underlying tissue under the applied magnetic field

$${B}_{a}^{( l )} .$$

A min-max formulation is employed to maximize the displacement at the control point, with the appropriate sign for the desired deformation modes.

The vector v collects element volumes, with its eth component vₑ denoting the volume of element denoting the volume of element e, and vₘₐₓ denotes the prescribed upper bound for volume fraction. To mitigate thin members and restrict excessive local deformations in optimized designs, a stress constraint is incorporated for each applied magnetic field. Here,

$${σ}_{0}^{( ℓ )}$$

approximates the maximum stress across the design domain, while

$${σ}_{max}^{( ℓ )}$$

serves as the upper limit for stress. The equilibrium

$$R = \frac{\partial {\sum }_{e} {W}_{e}^{( ℓ )}}{\partial {u}^{( ℓ )}} = 0$$

of the robot-tissue system (neglecting body force and external mechanical traction) is embedded in the formulation, where the displacement vector u(l) is solved using finite element analysis for each optimization iteration. The gradient-based optimization problem is addressed using the method of moving asymptotes (MMA).

### Example Finite Element Simulation

The evaluation of both optimized robot actuation performance and tissue deformations is conducted utilizing the nonlinear finite element method under large deformation. By adopting a total Lagrangian and excluding traction and body force, a displacement-based finite element problem is established with the total potential energy expressed as:

$$\prod ( {u}^{( ℓ )} ) = {\sum }_{e} ( {W}_{E , e} ( {u}_{e}^{( ℓ )} ) + {W}_{M , e} ( {u}_{e}^{( ℓ )} ) + {W}_{T , e} ( {u}_{e}^{( ℓ )} ) )$$

where W_{E,e} and W_{M,e} represent the elementwise stored energy for the matrix material and magnetic energy for the magnetic robot, respectively, and W_{T,e} denotes the elementwise stored energy for the tissue (or connector).

Minimizing the total potential energy Π(u) with respect to the global displacement vector u results in the discretized stationary condition:

$$R ( u ) = \frac{\partial \prod }{\partial u} ( u ) = {F}_{int} ( u ) = 0$$

which governs the equilibrium of the discretized system. The terms R(u) and Fᵢₙₜ refer to the global residual vector and global internal force vectors, respectively. In this study, the nonlinear equation is solved using the Newton-Raphson method, with implementation carried out on the Matlab platform.

### Example Statistical Analysis

Statistical analysis was performed using GraphPad Prism v6 and v8. Sample variance was tested using the F test. For samples with equal variance, the significance between the groups was analyzed by a two-tailed student's t test. For samples with unequal variance, a two-tailed Welch's t-test was performed. For multiple comparisons, a one-way analysis of variance (ANOVA) with post hoc Fisher's LSD test was used. The results were deemed significant at 0.01<*P≤0.05, highly significant at 0.001<**P≤0.01, and extremely significant at ***P≤0.001.

### Example Constitutive Models and Finite Element Simulation

The magnetic robots are assumed to be ideal hard-magnetic soft materials and can be modeled via a constitutive model previously developed. This model has been validated to possess prediction in good agreement with experimental results. The total Helmholtz free energy of magnetic robot per unit volume W_{R} in the reference configuration can be expressed as

$${W}_{R} ( F ) = {W}_{E} ( F ) + {W}_{M} ( F ) = {W}_{E} ( F ) - \frac{1}{{μ}_{0}} ( {FB}_{r} ) \cdot {B}_{a} ,$$

where W_{E}(F) is the hyperelastic stored-energy function for characterizing the nonlinear elasticity of the soft material; W_{M}(F) represents the magnetic potential energy; F is the deformation gradient; μ₀=1.257×10⁻⁶ H/m is the vacuum (or air) magnetic permeability; Bᵣ is the residual magnetic flux density in the reference configuration; and Bₐ is the applied magnetic flux density, which is assumed to remain uniform and unchanged. In this work, W_{E}(F) is taken to be a I₁-based model given by

$${W}_{E} ( F ) = {\sum }_{i = 1}^{2} \frac{{3}^{1 - {α}_{i}}}{2 {α}_{i}} {μ}_{i} ( {I}_{1}^{{α}_{i}} - {3}^{{α}_{i}} ) - {\sum }_{i = 1}^{2} {μ}_{i} ln J + \frac{{μ}^{′}}{2} {( J - 1 )}^{2}$$

where I₁=tr(C) is the first invariant of the right Cauchy-Green deformation tensor C=F^{T}F; J is the determinant of F; αᵢ (i=1, 2) are real-valued material parameters; μ′ and μ=μ₁+μ₂ are the first second Lamé constant under the initial state, respectively. Note that μ₁, μ₂, α₁, α₂ are material constants and need to be experimentally characterized. The last two terms in the expression describe compressibility. In the context of 2D simulation (plane stress), these terms are omitted, transforming the model into an incompressible one.

In this study, the bio-tissues are considered to be isotropic and homogeneous. The Ogden model is employed, which has gained widespread popularity as a constitutive model in soft tissue biomechanics, to model the nonlinearity of the biotissues. The stored-energy function is expressed as:

$${W}_{T} ( {λ}_{1} , {λ}_{2} , {λ}_{3} ) = {\sum }_{p = 1}^{2} \frac{{μ}_{p}}{{α}_{p}} ( {λ}_{1}^{{α}_{p}} + {λ}_{2}^{{α}_{p}} + {λ}_{3}^{{α}_{p}} - 3 ) - {\sum }_{i = 1}^{2} {μ}_{i} ln J + \frac{{μ}^{′}}{2} {( J - 1 )}^{2}$$

where λ₁, λ₂, λ₃ are the principal stretches depending on deformation gradient F; μ₁, μ₂, α₁, α₂ are material constants that need to be experimentally characterized. In the context of 2D simulation (plane stress), the last two terms are omitted, transforming the model into an incompressible one.

To model the connector material (elastomer) in 2D that is used for performance tests of the wireless magnetic robots, the incompressible I1-based model is used:

$${W}_{C} ( F ) = {\sum }_{i = 1}^{2} \frac{{3}^{1 - {α}_{i}}}{2 {α}_{i}} {μ}_{i} ( {I}_{1}^{{α}_{i}} - {3}^{{α}_{i}} ) ,$$

where the definitions of the variables and constants are the same as before.

A finite element method is used to simulate the magneto-mechanical performance of the robots and the underlying tissues. Adopting a total Lagrangian formulation and neglecting traction and body force, a displacement-based finite element problem is formulated with the total potential energy given by

$$\prod ( {u}^{( ℓ )} ) = {\sum }_{e} ( {W}_{E , e} ( {u}_{e}^{( ℓ )} ) + {W}_{M , e} ( {u}_{e}^{( ℓ )} ) + {W}_{T , e} ( {u}_{e}^{( ℓ )} ) ) ,$$

where W_{E,e} and W_{M,e} represent the elementwise stored energy for the matrix material and magnetic energy for the magnetic robot, respectively, and W_{T,e} denotes the elementwise stored energy for the tissue (or connector).

Minimizing the total potential energy Π(u) with respect to the global displacement vector u gives the discretized stationary condition

$$R ( u ) = \frac{\partial \prod }{\partial u} ( u ) = {F}_{int} ( u ) = 0 ,$$

which governs the equilibrium of the discretized system. R(u) and Fᵢₙₜ are referred to as the global residual vector and global internal force vectors, respectively. In this work, the nonlinear equation is solved using the Newton-Raphson method with the inexact line search method. This nonlinear solver makes use of consistently linearized tangent stiffness matrices, for which the “fsparse” routine is applied to enhance the computational efficiency of sparse matrix assembly. When simulating the 3D problem, reduced and selective integration is employed to address the locking issue, assuming a Poisson's ratio of 0.49 for both magnetic robots and tissues.

### Example Topology Optimization Framework

The design goal is to optimize the magnetic robots (both geometry and magnetization distributions) to achieve target deformation modes on tissues. First a design space parameterization scheme is presented that simultaneously parametrizes matrix material topology and remnant magnetization distribution. Then, how to use the parameterized variables to interpolate the energy functions to characterize the magneto-mechanical interaction between hard-magnetic soft material and tissues (or connectors) is presented. The finite element simulation for numerically computing the magneto-mechanical performance is briefly described. Lastly, the established optimization formulation for optimizing magnetic robots is reported.

The distribution of matrix characterizes the geometry of the biomaterial. Here, a density-based approach is adopted. The matrix geometry is described and associated with the density variable ρ with ρₑ for the eth element. The Heaviside projection operator is applied (with ½ being its threshold) to the density variable, obtaining the physical density variables \hat{ρ} with ρ̅ₑ given by

$${\overline{ρ}}_{e} = \frac{tanh ( \frac{{β}_{ρ}}{2} ) + tanh ( {β}_{ρ} ( {\tilde{ρ}}_{e} - \frac{1}{2} ) )}{2 tanh ( \frac{{β}_{ρ}}{2} )} ,$$

with β_{ρ} being the parameter controlling the discreteness of the projection, and being the intermediate design variable regularized via the density filter as follows:

$${\tilde{ρ}}_{e} = \frac{{\sum }_{i ∈ {ℐ}_{e} ( {R}_{ρ} )} {w}_{ρ}^{( i , e )} {v}_{i} {ρ}_{i}}{{\sum }_{i ∈ {ℐ}_{e} ( {R}_{ρ} )} {w}_{ρ}^{( i , e )} {v}_{i}} ,$$

where [symbol] (R_{ρ}) is the eth element set within a prescribed region defined by a circle with a radius of R_{ρ} at the centroid of eth element; and vᵢ is the ith element volume. The weighting factor

$${w}_{ρ}^{( i , e )} ( {R}_{ρ} , {q}_{ρ} )$$

depends on the distance between the centroids of ith and eth elements (denoted as xᵢ and xₑ, respectively), namely,

$${w}_{ρ}^{( i , e )} = 1 - {( ‖ {X}_{i} - {X}_{e} ‖ / {R}_{ρ} )}^{{q}_{ρ}} ,$$

with q_{ρ} being the power of the filter. The physical design variable ρ̅ₑ serves as an indicator of whether a given location in space is solid or void: ρ̅ₑ=1 represents solid and ρ̅ₑ=0 represents void.

The residual magnetic flux density at each location of the design is selected from a set of Nₘ pre-selected candidate residual magnetic flux densities,

$${B}_{r}^{( 1 )} , ... , {B}_{r}^{( {N}_{m} )}$$

each pointing at one direction. Formally, the residual magnetic flux density in element e is defined as

$${B}_{r , e} = {\sum }_{j = 1}^{{N}_{m}} {( {\overline{m}}_{e}^{( j )} )}^{{p}_{m}} {B}_{r}^{( j )}$$

In the above interpolation,

$${\overline{m}}_{e}^{( j )}$$

is the physical magnetization variable which serves as an indicator of the magnetization of element e:

$${\overline{m}}_{e}^{( j )} = 1$$

means the jth candidate residual magnetic flux density

$${B}_{r}^{( j )}$$

is selected, and

$${\overline{m}}_{e}^{( j )} = 0$$

means the jth candidate residual magnetic flux density

$${B}_{r}^{( j )}$$

is not selected. A Solid Isotropic Material with Penalization (SIMP)-type penalization power pₘ is introduced to penalize the mixture of candidate magnetizations and to promote the convergence of the physical magnetization variables

$${\overline{m}}_{e}^{( j )}$$

to either 1 or 0.

This work aims to promote discrete magnetization distribution and allow non-magnetized regions to appear in the design. The Hypercube-to-Simplex Projection (HSP) approach is applied to define

$${\overline{m}}_{e}^{( j )} .$$

By using HSP, the physical magnetization variables can automatically satisfy the following two constraints: 1)

$${\sum }_{j = 1}^{{N}_{m}} {\overline{m}}_{e}^{( j )} \leq 1$$

and 2)

$${\overline{m}}_{e}^{( j )} \geq 0 , ∀ j .$$

The HSP approach defines the physical magnetization variables

$${\overline{m}}_{e}^{( j )}$$

as

$${\overline{m}}_{e}^{( j )} = {\sum }_{i = 1}^{{2}^{{N}_{m}}} {s}_{i}^{( j )} ( {( - 1 )}^{( {N}_{m} + {\sum }_{j = 1}^{{N}_{m}} {c}_{i}^{( j )} )} {\prod }_{k = 1}^{{N}_{m}} ( {\overline{ξ}}_{e}^{( k )} + {c}_{i}^{( k )} - 1 ) )$$

where

$${\overline{ξ}}_{e}^{( j )}$$

is the magnetization variable subject to filtering and projection. The parameter

$${c}_{i}^{( j )} = \{ 0 , 1 \}$$

is the ith vertex of a Nₘ-dimensional unit hypercube for the jth candidate remnant magnetization vector, and

$${s}_{i}^{( j )}$$

is the mapped vertex of a Nₘ-dimensional standard simplex domain:

$${s}_{i}^{( j )} = \{ \begin{matrix}\frac{{c}_{i}^{( j )}}{{\sum }_{j = 1}^{{N}_{m}} {c}_{i}^{( j )}} & if {\sum }_{j = 1}^{{N}_{m}} {c}_{i}^{( j )} \geq 1 , \\ 0 & otherwise .\end{matrix}$$

To describe the nonlinear magneto-mechanical behavior of magnetic robot and tissues (or connectors), the following interpolation of the energy function from the physical variables ρ̅ and m̅^{(j)}, j=1, . . . , Nₘ is introduced. The interpolated element-wise energy

$${W}_{e}^{( ℓ )}$$

is given by

$${W}_{e}^{( ℓ )} ( {\overline{ρ}}_{e} , {\overline{m}}_{e}^{( 1 )} , … , {\overline{m}}_{e}^{( {N}_{m} )} , {u}_{e}^{( ℓ )} ) = [ ϵ + ( 1 - ϵ ) {( {\overline{ρ}}_{e} )}^{{p}_{ρ}} ] {W}_{E , e} ( F ( {u}_{e}^{( ℓ )} ) ) + {( {\overline{ρ}}_{e} )}^{{p}_{ρ}} {W}_{M , e} ( {u}_{e}^{( ℓ )} , {B}_{r , e} ( {\overline{m}}_{e}^{( 1 )} , … , {\overline{m}}_{e}^{( {N}_{m} )} ) ) + {W}_{T , e} ( F ( {u}_{e}^{( ℓ )} ) ) ,$$

where

$${u}_{e}^{( ℓ )}$$

is the displacement vector in element e under the 1-th applied magnetic field

$${B}_{a}^{( ℓ )} ; and ϵ = {10}^{- 5}$$

is a small value to avoid singular stiffness. In the above interpolation formula, the SIMP approach is used to penalize both elastic-stored energy and magnetic free energy to promote a discrete design. The penalization parameters p_{ρ} associated with both energies are taken to be the same. Based on numerical experience, excessive deformations of low-stiffness regions can lead to numerical instabilities during the optimization. Thus, an energy interpolation scheme is applied to the stored-energy W_{E} to address the numerical instabilities of low stiffness regions (defined to be regions with (ρ̅ₑ)^{p}^{_{ρ}}≤0.01). The same concept is also applied to the magnetic free energy W_{M} so that the magnetic actuation in low-stiffness regions is negligible. The symbol W_{T} refers to the stored energy of tissues. They are not in the design space, thus their stored energy is not associated with design variables.

With the introduced design space parameterization and free-energy interpolation schemes, the topology optimization formulation to generate the magneto-active biorobots is presented. The mesh Ωₕ is composed of Nₑ elements and Nₙ nodes. The goal of the topology optimization is to maximize the tissue displacements at control points with the constraints and the nested equilibrium satisfied. Formally, the topology optimization problem is formulated as:

$${min}_{ρ , {ξ}^{( 1 )} , … , {ξ}^{( {N}_{m} )}} {max}_{{ℓ ∈ \{ 1 , … , {N}_{ℓ} \}}_{α ∈ \{ 1 , … , {N}_{α}^{( ℓ )} \}}} {u}_{α}^{( ℓ )} , \\ \begin{matrix}s . t . : & \frac{{v}^{T} \overline{ρ}}{\vert {Ω}_{h} \vert} \leq {v}_{m ax} , \\ & {\{ {\sum }_{e = 1}^{{N}_{e}} {[ \frac{{ω}_{σ} ( {\overline{ρ}}_{e} )}{{v}_{e}} {\int }_{{Ω}_{h , e}} {σ}_{VM} ( {σ}_{E} ( {u}^{( ℓ )} ) ) dX ]}^{{p}_{n}} \}}^{1 / {p}_{n}} \leq {σ}_{m ax}^{( ℓ )} , ℓ = 1 , … , {N}_{ℓ} , \\ & R ( \overline{ρ} , {\overline{m}}^{( 1 )} , … , {\overline{m}}^{( {N}_{m} )} , {u}^{( ℓ )} ) = 0 , ℓ = 1 , … , {N}_{ℓ} , \\ & 0 \leq ρ \leq 1 , \\ & 0 \leq {ξ}^{( j )} \leq 1 , j = 1 , … , {N}_{m} ,\end{matrix}$$

where u_{α}^{(l)} is the actual displacement at the α-th control degree of freedom (DOF) of the underlying tissue under applied magnetic field B_{α}^{(l)}; v is a vector collecting element volumes with its eth component vₑ being the volume of element e, and vₘₐₓ is the prescribed maximum volume fraction. A min-max formulation is employed to maximize the displacement at the control point, with the appropriate sign for the desired deformation modes. To eliminate thin members and limit excessive local deformations in optimized designs, an aggregated von Mises stress constraint is introduced (using the p-norm approximation with the factor pₙ) for each applied magnetic field. The element-level von Mises stress σ_{VM} is computed from the mechanical part of the Cauchy stress σ_{E}. The stress relaxation approach is adopted giving

$${ω}_{σ} ( {\overline{ρ}}_{e} ) \dot{=} ϵ + ( 1 - ϵ ) {\overline{ρ}}_{e}^{q}$$

with q being ½.

The proposed formulation is solved by a gradient-based method of moving asymptotes (MMA).

The sensitivities information of objective and constraint functions with respect to the design variables are derived by the adjoint method.

### Example Fabrication and Characterization of Biomaterials and Tissues

In this study, uniaxial tensile and compressive tests are conducted on porcine skeletal muscle, liver, and myocardium tissue samples. To ensure consistent sample dimensions, 3D-printed cutting guides (for tension: 61 mm×12 mm×5 mm; for compression: 10 mm×10 mm×10 mm) are used to cut the samples into the desired shape. After the tissue strips were prepared, uniaxial tension and compression experiments are performed at room temperature. The experiments are conducted using a loading machine (Instron 68TM-30). The prepared samples and specific setups are illustrated in FIGS. 8A-8C. For the uniaxial tension experiments, the tissue samples are fixed in clamps covered with sandpaper from the inside to avoid tissue slippage. Tension experiments are carried out until the sample failed. For performing the compression experiments, tissue samples are positioned between two “T”-shape steel loading bars. Before placing the samples between the loading bars, they are sprayed with silicon oil to avoid friction. All the tests are performed at a strain rate of 0.5%/s. The force data F is directly obtained from the loading machine, and the nominal stress data is calculated by P=F/A, where A is the cross-sectional area of the undeformed tissue sample, which is taken as the averaged value measured at three locations. For the tensile testing, to get the strain data, speckle patterns are sprayed on the surface of the tissue samples. The loading history is video-recorded using a commercial camera (SONY α7R), and images are sampled according to the frequency of the force. Digital image correlation analysis is performed using the Matlab toolbox “ncorr” to obtain the displacement field, from which strain is calculated based on the displacement of an extensometer line within the range of uniform strain. For the compressive testing, the strain information is directly obtained from the loading machine. FIGS. 8D-8F show the measured stress-strain curves and the corresponding fitted curves using the Ogden model for the three types of tissues.

The biomaterials investigated in this study include the hard magnetic soft material (HMSM) made of PDMS elastomer (20:1 base-to-agent ratio) with 0 vol % (pure PDMS), 15 vol %, and 25 vol % NdFeB magnetic particles, and Eco-flex 00-30 used to make connectors for the robots' performance tests. The mechanical properties of these biomaterials are determined by fitting the parameters in the constitutive model to the experimentally obtained uniaxial stress-strain relationships. The compression and tension testing samples are fabricated following the standard as shown in FIGS. 9A-9B. The results for the measured and fitted stress-strain curves for the biomaterials are presented in FIGS. 9C-9F. The fitted material constants (α1, μ1, α2, μ2) are given in the figures.

The digital image correlation (DIC) approach is employed to capture the full-field displacement of the tissue during magnetic actuation. Initially, speckle patterns were applied to the tissue surface using RUST-OLEUM spray paint, featuring a diameter size of 3-5 pixels. A SONY α7R camera with the FE 24-70 mm F2.8 GM II Lens was positioned appropriately to record the actuation process from the undeformed to the deformed state at a frame rate of 29.97 frames/second. Note that since the magnetic actuation is quite fast and the induced tissue strain is relatively larger, to ensure the effectiveness and accuracy of the DIC analyzed results, every frame between the initial undeformed and the final deformed frames is extracted from the recorded video. Subsequently, these extracted images underwent batch processing in Photoshop to accommodate a better field-of-view and adjust pattern contrast. For instance, in the shearing mode analysis, the processed image resolution is of 2166×2160 pixels. The images were then imported to the open source Ncorr package in Matlab to calculate the displacement fields. The areas covered by the robots were excluded from the region-of-interest. The resulting displacement fields have a resolution of 0.0288 mm/pixel. A subset with radius of 1.786 mm and spacing of 0.144 mm was chosen. To accommodate large displacements, the high-strain analysis feature was enabled. The correlation algorithm consistently updated the reference image, and the analysis was executed in a backwards manner to appropriately handle the rapid deformation. In this process, the final deformed image served as the reference, and all subsequent correlations were conducted in relation to it.

### Example Devices

FIG. 12A illustrates a device 1200 according to an example embodiment. In various examples, the device 1200 includes a plurality of composite elements 1202. Each composite element (e.g., 1202a, 1202b, 1202c) includes a soft matrix material 1204 with embedded magnetic particles 1206. The magnetic particles 1206 allow each composite element (e.g., 1202a, 1202b, 1202c) to have one or more magnetic domains 1208 in a given orientation. The device 1200 that includes the plurality of composite elements 1202 is configured into an initial state 1210 which is shown in FIG. 12B. In the presence of an applied magnetic field 1214, the device 1200 is displaced from an initial state 1210 to an actuated state 1212.

Some embodiments are described as a “robot”. The term “robot” is herein used to describe the device 1200 comprising a plurality of composite elements 1202.

In some examples, the device 1200 may be scaled to any dimension for a given application. In the example embodiments disclosed here, devices are shown with a size of 30 mm (length)×30 mm (width)×10 mm (thickness). However larger or smaller devices may also be made and used. In some embodiments, the device thickness is constant but varies along the other two dimensions with a specified planar geometry. Other types of three-dimensional device structures are also possible in various embodiments.

In various example embodiments, the device 1200 may consist of a plurality of individual composite elements (e.g., 1202a, 1202b, 1202c). Alternatively, the device 1200 may consist of a single composite element (e.g., 1202a, 1202b, 1202c). Each composite element (e.g., 1202a, 1202b, 1202c) may have a specific orientation of the magnetic domains 1208 or the composite element may be demagnetized. Individual composite elements (e.g., 1202a, 1202b, 1202c) may be attached to each other forming a single piece, or they may remain as individual isolated composite elements within the plurality of composite elements 1202. Collectively, the plurality of composite elements 1202 is arranged in the geometry of the initial state 1210.

The initial state 1210 describes the starting position of the plurality of composite elements 1202. The plurality of composite elements 1202 is fabricated and arranged into the initial state 1210 without the presence of an applied magnetic field 1214. When the device 1200 is in the presence of an applied magnetic field 1214, the magnetic domains 1208 in the composite elements align with the applied magnetic field 1214 causing the device 1200 to be displaced from the initial state 1210 to the actuated state 1212. The actuated state 1212 describes the positioning of the plurality of composite elements 1202 while under the influence of an applied magnetic field 1214.

In example embodiments, the soft matrix material 1204 is made of a biocompatible polymer. The biocompatible polymer may be polydimethylsiloxane (PDMS) or polybutylene adipate terephthalate (PBAT). Other biocompatible polymers may also be used in other embodiments. The use of a biocompatible polymer as the soft matrix material 1204 allows the device 1200 to be directly placed on body tissues. The soft matrix material 1204 may also be mechanically compliant such that the device 1200 is able to be displaced from the initial state 1210 to the actuated state 1212.

In example embodiments, the magnetic particles 1206 could be permanent (“hard”) magnets, such as NdFeB. Other permanent magnet materials may be used. In some embodiments, the particle size of the magnetic particles 1206 is on the order of 25 μm. It will be understood that other particle size values are contemplated and possible.

In some embodiments, the material comprising the soft matrix material 1204 with magnetic particles 1206 is referred to as a “hard-magnetic soft material”. The magnetic particles 1206 may make up 15 vol %-40 vol % of the total material. It will be understood that other vol % values are contemplated and possible.

In example embodiments, the device 1200 is configured to be adhered to or placed on internal or external body tissues. Internal body tissues may include, but are not limited to, skeletal muscles, liver tissue, or myocardium. The device 1200 may be adhered to any other organs or muscles as well. External body tissues may include but are not limited to the skin. While example embodiments show use with body tissues belonging to pigs and mice, the device 1200 may be used on body tissues of any animal, including humans.

In example embodiments, the device 1200 may be securely adhered to body tissues using a variety of adhesives including super glue, hydrogel sealants or adhesives, or cyanoacrylates. Other bioadhesives with high adhesion strength and good biocompatibility may be used. In place of or in addition to adhesives, the device 1200 may be secured using other methods like sutures, tape, or otherwise placed on the body tissues.

In example embodiments, the plurality of composite elements 1202 is configured to mechanically stimulate the internal or external body tissues in the presence of an applied magnetic field 1214. The applied magnetic field 1214 causes the device 1200 to be displaced from the initial state 1210 to the actuated state 1212. This movement between states allows the underlying tissue to be stimulated allowing for this device 1200 to be used for various mechanotherapy applications.

### Example Methods

FIG. 13 illustrates a method 1300 for fabricating a device, according to example embodiments. The method 1300 may include blocks or steps that may be carried out or performed in any order. Some blocks or steps of method 1300 could be carried out in series or parallel, and steps or blocks may be repeated.

Block 1302 includes determining an initial state geometry (e.g., initial state 1210) and respective orientations of magnetic domains (e.g., magnetic domains 1208) for a plurality of composite elements (e.g., plurality of composite elements 1202). In such scenarios, the plurality of composite elements could be configured to be displaced into an actuated state (e.g., actuated state 1212) in the presence of an applied magnetic field (e.g., applied magnetic field 1214).

In example embodiments, the determination of the initial state geometry 1210 and the respective magnetic domain orientations (e.g., magnetic domains 1208) for the plurality of composite elements 1202 within the device 1200 is done using a topology morphogenesis process or optimization for a desired deformation mode.

“Optimization” as used herein could mean a local minimum or local maximum and is not necessarily a global minimum or global maximum. Optimization results may vary depending on the desired behavior, the inputs, and the constraints, as well as the underlying assumptions of the topology model.

In example embodiments, the desired deformation mode defines a type of deformation between the initial state 1210 and the actuated state 1212. This mode can be selected for a given application and can include uniaxial or biaxial stretching or compressing, shearing, or a combination of multiple distinct modes. In various examples, other two-dimensional and three-dimensional deformation modes are possible and contemplated.

For example, the device 1200 may be designed with biaxial stretching/compressing as the target deformation mode. In an example embodiment of this case, the device 1200 is designed to allow for compression along both the x-axis and y-axis when the applied magnetic field 1214 is applied in one direction. When the applied magnetic field 1214 is applied in the opposite direction, the device 1200 is designed to stretch along the x-axis and y-axis.

In another example embodiment for the uniaxial case, the device 1200 is designed to stretch along one direction (for example the x-direction), and be compressed along the other planar direction (for example, the y-direction) in the presence of an applied magnetic field 1214.

In another example embodiment, the device 1200 could be designed for shearing, such that the device 1200 rotates in the presence of an applied magnetic field 1214.

In example embodiments combining different desired deformation modes, the device 1200 may be designed to exhibit different behavior depending on the direction of the applied magnetic field 1214. For example in the case of a dual-mode device for shearing and stretching, if the applied magnetic field 1214 is applied in one direction the device 1200 will stretch, whereas if the applied magnetic field 1214 is applied in a different direction the device 1200 is designed to shear by rotating.

In example embodiments, the topology process to determine the geometry of the initial state 1210 and the respective orientations of magnetic domains 1208 may include a number of inputs. For example, these inputs may include the mechanical properties of the soft matrix material 1204 with the magnetic particles 1206, the mechanical properties of the target body tissues, the magnitude of the applied magnetic field 1214, and the desired deformation mode.

In example embodiments, a number of constraints may also be applied. For example there may be constraints set to limit the dimensions of the device 1200 and to mitigate the presence of features that are too thin to be mechanically robust. The optimization may only consider two-dimensional in-plane geometry or it could be extended to consider a three-dimensional geometry. From the inputs and constraints, the iterative topology process generates an optimized geometry of the initial state 1210 and corresponding orientations of the magnetic domains 1208 for each composite element (e.g., 1202a, 1202b, 1202c) in the initial state 1210.

Block 1304 includes forming at least one mold based on the determined initial state geometry 1210 and respective magnetic domain orientation 1208.

In example embodiments, forming the at least one mold involves 3-D printing one or more molds with polyvinyl alcohol (PVA). Other embodiments could include different 3-D printed materials. The mold could also be formed using more traditional manufacturing techniques instead of additive manufacturing.

Depending on the pre-determined geometry of the initial state 1210, there may be only one mold required to form the device 1200 or there may be multiple molds required to form the device 1200. Additionally, one mold could be configured to form multiple composite elements (e.g., 1202a, 1202b, 1202c). Each composite element (e.g., 1202a, 1202b, 1202c) with a single magnetic orientation may be formed individually.

Block 1306 includes casting, by way of the at least one mold, the plurality of composite elements 1202.

In example embodiments, individual composite elements (e.g., 1202a, 1202b, 1202c) are formed in the molds by first mixing the soft matrix material 1204 with magnetic particles 1206. This mixture may contain 15 vol %-40 vol % magnetic particles 1206. This mixture may then be introduced into the molds, allowing for the casting of the plurality of composite elements 1202.

In example embodiments, the composite elements (e.g., 1202a, 1202b, 1202c) may then be cured at an elevated temperature. For example, this curing temperature in some embodiments may be about 80° C. Temperatures may be high enough to allow for the composite element to properly cure without risking melting the material of the mold. After the composite elements are cured, they may be removed from the mold through a demolding step. Demolding may include releasing, peeling, or otherwise removing the composite elements from the mold. The mold may be left intact or it may be broken through demolding to release the composite elements.

Block 1308 includes adjusting, with an external magnetic saturation field, an orientation of at least one magnetic domain 1208 of at least one composite element (e.g., 1202a, 1202b, 1202c).

In example embodiments, adjusting the orientation of the at least one magnetic domain 1208 of the at least one composite element (e.g., 1202a, 1202b, 1202c) may involve aligning the at least one magnetic domain using an impulse magnetic field. Using the pre-determined initial state geometry 1210 and the orientations of the magnetic domains 1208 from the topology process, individual composite elements (e.g., 1202a, 1202b, 1202c) may be magnetized in specific directions. This magnetization occurs using an external magnetic saturation field to align the magnetic domains 1208 along a specific direction. Some composite elements (e.g., 1202a, 1202b, 1202c) may be left demagnetized. This external magnetic saturation field may be provided by a variety of strong magnets such as an impulse magnetic field with a magnitude of 2T. In example embodiments the magnitude of the external magnetic saturation field is larger than the applied magnetic field (e.g., applied magnetic field 1214).

In some embodiments, the plurality of composite elements 1202 may be bonded to one another forming a single piece. Alternatively, in some embodiments the device 1200 may comprise only one composite element (e.g., 1202a, 1202b, 1202c) or the composite elements may be left unattached.

In example embodiments, a second mold is formed based on the initial state geometry 1210. In some embodiments, the second mold may be formed from 3-D printed PVA. The method may then include introducing a plurality of composite elements 1202 into the second mold. One or more of these composite elements may then be bonded to each other while fixed in the desired arrangement/geometry. This bonding may be done using an adhesive or additional soft matrix material 1204.

Once the device 1200 is configured into the initial state 1210 geometry, it may be adhered to internal or external body tissues. Alternatively, the device 1200 may be placed on the internal or external body tissues.

### Example Systems

In another aspect, a system 1400 is described that could include the device 1200 (as described in reference to FIG. 12) and a controllable magnet 1410 as shown in FIG. 14.

In example embodiments, the controllable magnet 1410 may include a permanent magnet or an electromagnet. The controllable magnet 1410 generates an applied magnetic field (e.g., applied magnetic field 1214) that is used to displace the device (e.g., device 1200) from its initial state (e.g., initial state 1210) to its actuated state (e.g., actuated state 1212).

In example embodiments, the controllable magnet 1410 can be controlled through a variety of methods. For example, in the case of an electromagnet, the magnet may be powered by an external power supply where the applied magnetic field 1214 is set by changing the current applied by the power source. In the case of a permanent magnet, the magnet may be controlled by physically moving the position of the magnet with respect to the device 1200.

In example embodiments involving the electromagnetic. The power supply may use a variety of different electric currents to control the magnet. For example the current may be alternating current (AC) or direct current (DC).

In example embodiments, the controllable magnet 1410 may be configured such that it cycles between and on state and off state at a desired actuation rate. The magnitude of the applied magnetic field 1214 may be in the range of 10-80 mT. The actuation rate may be in the range of 0.05-0.5 Hz. The controllable magnitude of the applied magnetic field 1214 could be modulated according to a square wave or a sine wave.

In some embodiments, the device 1200 may be configured to be adhered to or placed on an external or internal body tissue. When the applied magnetic field 1214 repeatedly oscillates between an on state and an off state, the device 1200 switches back and forth between the initial state 1210 and the actuated state 1212 at the actuation rate.

In some example embodiments, the plurality of composite elements 1202 in the device 1200 is configured to mechanically stimulate the internal or external body tissues. This mechanical stimulation is caused by the repeated displacement of the device in the presence of the applied magnetic field 1214 from the controllable magnet 1410. This allows the device 1200 to be used for mechanotherapy applications.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

Unless otherwise explained, all technical and scientific terms used herein have the same meaning as commonly understood by one of ordinary skill in the art to which a disclosed disclosure belongs. The singular terms “a,” “an,” and “the” include plural referents unless context clearly indicates otherwise. Similarly, the word “or” is intended to include “and” unless the context clearly indicates otherwise. “Comprising” means “including”; hence, “comprising A or B” means “including A” or “including B” or “including A and B.” All references cited herein are incorporated by reference.

The disclosure may be further understood by the following non-limiting examples. All references cited herein are hereby incorporated by reference to the extent not inconsistent with the disclosure herewith. Although the description herein contains many specificities, these should not be construed as limiting the scope of the disclosure but as merely providing illustrations of some of the presently preferred embodiments of the disclosure. For example, thus the scope of the disclosure should be determined by the appended aspects and their equivalents, rather than by the examples given.

While the present disclosure can take many different forms, for the purpose of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications of the described embodiments, and any further applications of the principles of the disclosure as described herein are contemplated as would normally occur to one skilled in the art to which the disclosure relates.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure. Thus, it should be understood that although the present disclosure has been specifically disclosed by preferred embodiments, exemplary embodiments and optional features, modification and variation of the concepts herein disclosed may be resorted to by those skilled in the art, and that such modifications and variations are considered to be within the scope of this disclosure as defined by the appended aspects. The specific embodiments provided herein are examples of useful embodiments of the present disclosure and it will be apparent to one skilled in the art that the present disclosure may be carried out using a large number of variations of the devices, device components, methods steps set forth in the present description. As will be obvious to one of skill in the art, methods and devices useful for the present methods can include a large number of optional composition and processing elements and steps.

Every formulation or combination of components described or exemplified herein can be used to practice the disclosure, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the aspects herein.

All patents and publications mentioned in the specification are indicative of the levels of skill of those skilled in the art to which the disclosure pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are disclosed, it should be understood that compounds known and available in the art prior to Applicant's disclosure, including compounds for which an enabling disclosure is provided in the references cited herein, are not intended to be included in the composition of matter aspects herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the disclosure without resort to undue experimentation. All art-known functional equivalents, of any such materials and methods are intended to be included in this disclosure. The terms and expressions which have been employed are used as terms of description and not of limitation, and there is no intention that in the use of such terms and expressions of excluding any equivalents of the features shown and described or portions thereof, but it is recognized that various modifications are possible within the scope of the disclosure. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this disclosure as defined by the appended aspects.

Although the present disclosure has been described with reference to certain embodiments thereof, other embodiments are possible without departing from the present disclosure. The spirit and scope of the appended aspects should not be limited, therefore, to the description of the preferred embodiments contained herein. All embodiments that come within the meaning of the aspects, either literally or by equivalence, are intended to be embraced therein. Furthermore, the advantages described above are not necessarily the only advantages of the disclosure, and it is not necessarily expected that all of the described advantages will be achieved with every embodiment of the disclosure.

What is claimed is:

1. A device comprising:
a plurality of composite elements, wherein each composite element comprises a soft matrix material and magnetic particles embedded in the soft matrix material, wherein the magnetic particles provide one or more magnetic domains having a given orientation, wherein the plurality of composite elements is provided in an initial state, and wherein the plurality of composite elements is configured to be displaced into an actuated state in the presence of an applied magnetic field.

2. The device of claim 1, wherein the soft matrix material comprises a biocompatible polymer, wherein the biocompatible polymer further comprises at least one of: polydimethylsiloxane (PDMS) or polybutylene adipate terephthalate (PBAT).

3. The device of claim 1, wherein the magnetic particles comprise NdFeB.

4. The device of claim 1, wherein the device is configured to be adhered to or placed on internal or external body tissues.

5. The device of claim 4, wherein the device may be adhered to internal or external body tissues using super glue, biocompatible adhesives, or sutures.

6. The device of claim 4, wherein the plurality of composite elements is further configured to mechanically stimulate the internal or external body tissues when displaced from the initial state to the actuated state.

7. A method comprising:
determining an initial state geometry and respective magnetic domain orientation for a plurality of composite elements, wherein the plurality of composite elements is configured to be displaced into an actuated state geometry in the presence of an applied magnetic field;
forming at least one mold based on the determined initial state geometry and respective magnetic domain orientation;
casting, by way of the at least one mold, the plurality of composite elements; and
adjusting, with an external magnetic saturation field, an orientation of at least one magnetic domain of at least one composite element.

8. The method of claim 7, wherein determining the initial state geometry and the respective magnetic domain orientation is based on an iterative topology morphogenesis process and a desired deformation mode.

9. The method of claim 8, wherein the desired deformation mode defines a type of deformation between the initial state and the actuated state, wherein the desired deformation mode comprises at least one of: compression, stretching, or shearing.

10. The method of claim 7, wherein forming the at least one mold comprises 3-D printing the at least one mold using polyvinyl alcohol (PVA).

11. The method of claim 7, further comprising mixing a soft matrix material and magnetic particles in a ratio of 15 vol %-40 vol % magnetic particles to form a mixture, wherein casting the plurality of composite elements comprises introducing the mixture into the at least one mold.

12. The method of claim 11, further comprising:
curing the mixture at an elevated temperature; and
demolding the composite elements.

13. The method of claim 7, wherein adjusting the orientation of the at least one magnetic domain of the at least one composite element comprises aligning the at least one magnetic domain using an impulse magnetic field.

14. The method of claim 7, further comprising:
forming a second mold, wherein the second mold is based on the initial state geometry;
introducing a plurality of the composite elements into the second mold; and
bonding one or more of the composite elements to one another using an adhesive or additional soft matrix material to form an assembled device.

15. The method of claim 14, further comprising:
adhering the assembled device to internal or external body tissues; or
placing the assembled device onto internal or external body tissues.

16. A system comprising:
a device, wherein the device comprises:
a plurality of composite elements, wherein each composite element comprises a soft matrix material and magnetic particles embedded in the soft matrix material, wherein the magnetic particles provide one or more magnetic domains having a given orientation, wherein the plurality of composite elements is provided in an initial state, and wherein the plurality of composite elements is configured to be displaced into an actuated state in the presence of an applied magnetic field; and
a controllable magnet.

17. The system of claim 16, wherein the controllable magnet comprises at least one of: a permanent magnet or an electromagnet.

18. The system of claim 16 wherein the controllable magnet is configured to generate the applied magnetic field that cycles between an on state and an off state at a desired actuation rate.

19. The system of claim 18, wherein the device is configured to be adhered to or placed on internal or external body tissues.

20. The system of claim 19, wherein the plurality of composite elements is further configured to mechanically stimulate the internal or external body tissues when displaced from the initial state to the actuated state in the presence of the applied magnetic field.
